(19) United States
(12) Patent Application Publication
(10) Pub. No.: US 2012/0084188 A1
(43) Pub. Date: Apr. 5, 2012

(54) Method for interactively collaborating across online social networking communities

(76) Inventor: Thomas Zuber, Los Angeles, CA (US)

(21) Appl. No.: 13/324,980

(22) Filed: Dec. 13, 2011

Related U.S. Application Data
(63) Continuation-in-part of application No. 12/493,096, filed on Jun. 26, 2009.
(60) Provisional application No. 61/481,668, filed on May 2, 2011.
(60) Provisional application No. 61/465,407, filed on Mar. 18, 2011.

(51) Int. Cl. G06F 15/16; G06Q 40/00; G06Q 30/04

(52) U.S. Cl. 705/34; 709/206; 705/30

(57) ABSTRACT

A method for interactively collaborating across several related but independent online social networking communities. Members of each networking communities share a common background or profession, such as being part of the medical, legal or banking industries. Each member has a profile associated with his or her networking community, by which they can interact with other members of the networking community to share contacts, documents, or other productivity functionalities. Members can also interact across networking communities via their networking profile. For example, a doctor who can use his profile from the medical networking community to interact with a lawyer who has a profile on the legal networking community. By promoting cross-community interaction, each group is able to increase their ability to communicate or share ideas and work product via the plurality of networking communities.

### CROSS REFERENCE TO RELATED APPLICATIONS

This application claims benefit under 35 U.S.C. 119(e) to U.S. Provisional Patent Application Ser. No. 61/481,668, filed May 2, 2011, entitled “A method for interactively collaborating across online social networking communities.” This application claims benefit as a continuation-in-part of U.S. patent application Ser. No. 12/493,096, filed on Jun. 26, 2009, the contents of which are hereby incorporated in the entirety. This application is also related to U.S. patent application Ser. No. 12/575,442, filed on Oct. 7, 2009, U.S. patent application Ser. No. 12/885,325, filed on Sep. 17, 2010, U.S. patent application Ser. No. 13/011,655, filed on Jan. 21, 2011, U.S. patent application Ser. No. 13/023,461, filed on Feb. 8, 2011, U.S. Patent Application No. 61/465,407, filed on Mar. 18, 2011, and U.S. patent application Ser. No. 13/109,556, filed on May 17, 2011. The contents of each of these patent applications are hereby incorporated in their entirety.

### BACKGROUND OF THE INVENTION

The present invention relates to systems and methods for interactive collaboration within a plurality of secure, online social networking communities made up of virtual identities enabled with multiple social networking functionalities, document management functionalities, and integrative functionalities.

Social networking websites, such as Facebook.com and MySpace.com, are communities of persons having virtual identities enabled with social networking functionalities. Such sites are often geared towards users having special recreational or social interests such as baseball games, motorcycle riding or dating. There are also social networking web sites for professionals—for example, LinkedIn.com, EsqChat.com and LegallyMinded.com—and some of these sites are communities of persons having virtual identities enabled with social networking functionalities. However, such social networking web sites do not include integration with a secured document management system, which integration provides synergies that facilitate viral online growth, as well as the foundation for the conception and creation of integration functionalities that facilitate business networking, operations and transactions.

One drawback of existing social networking communities is that each is self-contained and does not allow for the easy interaction between members of distinct communities. Thus, for example, a member of LinkedIn.com might connect with many other members of LinkedIn.com. However, a member of LinkedIn.com, cannot easily interact with a member of MySpace.com using the first member's LinkedIn.com member profile and the second member's MySpace.com member profile. Instead, the members must exchange profile information and reconnect with each other using each separate social networking community.

The prior art also discloses document management systems, meaning systems for managing, creating, editing, deleting, saving, organizing and accessing documents. For instance, Microsoft Office®, more particularly, its Word®, Excel®, and Power Point® applications, allow for creating, editing, deleting, saving and accessing of documents. Microsoft Office® also includes an Outlook® application that allows creating, editing, deleting, saving, accessing, sending and receiving emails. Another prior art system, Interwoven, Inc., offers a document management system that allows for organizing, storing and retrieving documents.

Other, more specialized functionalities exist to address the needs of particular professions. By way of example, in the legal profession, there exist billing and timekeeping tools, legal research tools, document review and production tools, and the like. Likewise, within the medical or dental professions, there exist patient file management tools, diagnosis tools, and the like. The accountancy profession might have functionalities including client auditing tools, compliance tools, or similar.

Thus, there remains a need for a truly cooperative community of virtual identities that enable a plurality of social networking functionalities. There furthermore remains a need for a system and method that allows members of one social networking community to interact with members of other, distinct social networking communities without requiring members of the first community to become members of each other community. Finally, there remains a need for the integrative functionalities the creation of which is conceivable and made possible in the context of such integration, which integrative functionalities will facilitate business networking, operations and transactions, and allow cloud computing portals for document management systems to more fully tap the viral power of the internet as enabled by social networking functionalities.

### BRIEF SUMMARY OF THE INVENTION

The future of web-based computing is rapidly taking shape. Emerging trends include such concepts as cloud computing and Web 2.0, in which a web or cloud-based infrastructure designed for rapid delivery of computing resources is made available through either a public or private provider. While many definitions of these concepts exist, the next generation of computing architecture will focus on delivering business and consumer services with a user focus, designed to encourage rapid innovation and efficient, collaborative decision making. Many market participants are actively trying to develop a dominant online portal for cloud computing, although none has yet done so.

The present invention describes an integration of cloud computing-based services through a portal that combines social networking functionalities with document management system functionalities, further enhanced with integrative functionalities as described herein.

The present invention discloses a secure, network-based collaborative work environment in which one or members of an online community having virtual identities enabled with social networking functionalities and document management functionalities are able to access and utilize a variety of integrative functionalities as fully described herein. The integrative functionalities include, but are not limited to:

clicking on an icon on a virtual identity existing in the context of a social networking website and thereby giving the person associated with such virtual identity access to (or retracting access of the person associated with such virtual identity to) a document management room shared by a network that at least some persons associated with virtual identities do not have access to;

clicking and dragging a document stored in a first folder containing documents shared by members of a first network of members (and not shared with members not of said first network) to a second folder containing documents shared by members of a second network (and not shared with members not of said second network), such that the document is shared with members of the first network and members of the second network, wherein at least one of said members of said second network is not also a member of said first network;

clicking and dragging a document stored in a first folder containing documents shared by members of a first network of members (and not shared with members not of said first network) to a second folder containing documents shared by members of a second network (and not shared with members not of said second network), such that the document is shared with members of the first network and members of the second network, and such that the document appears on the second network virtual identity page (e.g.: the Secure Loop Profile page), wherein at least one of said members of said second network is not also a member of said first network;

having software applications that import contact information from member virtual identities, thereby allowing to auto-fill of contact information in the context of document drafting, mail merge applications in the context of mass distributions, etc. (e.g.: thereby effectively eliminating the need to obtain a new business acquaintance's business card, create a new contact file (i.e.: in a contact file management program like Outlook®) containing the new business acquaintance's contact information, or ever update such contact file—just add the business acquaintance's member virtual identity, which will contain contact information updated by the business acquaintance himself/herself); and furthermore allowing members of a network of members to share a pool of virtual identity contacts, such that members not of the at least one network of members do not have access to the pool of virtual identity contacts.

Each member having a virtual identity or profile belongs to a community associated primarily with a particular profession or trade. For example, a legal community, a medical community, a dental community, an accounting community, a government employee community, and an engineering community. Other communities are possible, and indeed are contemplated by this invention. As a member of one of these communities, the member is able to take advantage of the functionalities described above to interact with other members of the community. It is an object of this invention to also provide a means whereby members may also share compatible functionalities and interact across communities. For example, a member of the medical community, using his medical community member profile, may join a network of legal professionals that is part of the legal community; for instance, a network created within the legal community for the purpose of working together on a litigation matter requiring expert testimony from the member of the medical community. Thus, not only can members of distinct networks within a community interact with one another, but members of distinct communities may freely interact with members of other communities.

Other features and advantages of the present invention will become more apparent from the following description of the embodiments, taken together with the accompanying several views of the drawings, which illustrate, by way of example, the principles of the invention.

### BRIEF DESCRIPTION OF THE SEVERAL VIEWS OF THE DRAWING

FIG. 1 is a conceptual diagram of a system and method of providing an online social community with integrative functionalities according to one embodiment of the present invention;

FIG. 2 is an exemplary graphical implementation of one aspect of the present invention showing a member's virtual identity and having several integrative functionalities accessible;

FIG. 3 is an exemplary graphical implementation of another aspect of the present invention showing multiple views of a document management system;

FIG. 4 is an exemplary implementation of another aspect of the present invention showing information on a member's virtual identity and implementation of integrative functionalities therein;

FIG. 5 is an exemplary graphical implementation of another aspect of the present invention showing a home page;

FIG. 6 is an exemplary graphical implementation of another aspect of the present invention showing a member profile;

FIG. 7 is an exemplary graphical implementation of another aspect of the present invention showing a member profile as viewed by members who are not contacts;

FIG. 8 is an exemplary graphical implementation of another aspect of the present invention showing a member profile of a second members as viewed by an owner;

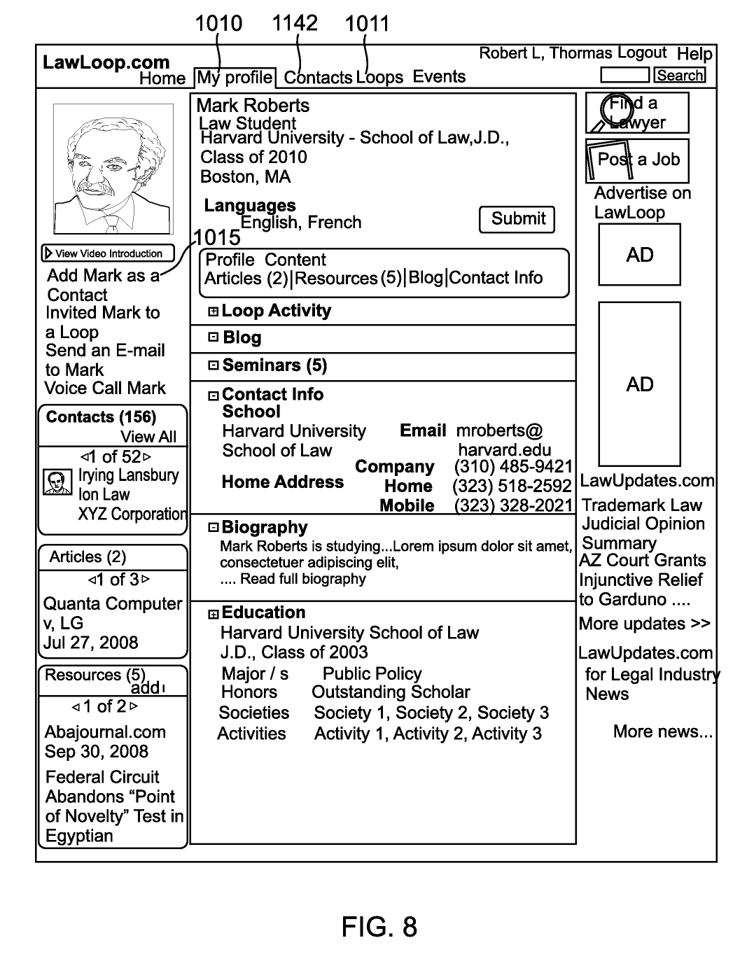

FIG. 9 is an exemplary graphical implementation of another aspect of the present invention showing a member profile as viewed by members who are contacts;

FIG. 10 is an exemplary graphical implementation of another aspect of the present invention showing lists of contacts;

FIG. 11 is an exemplary graphical implementation of another aspect of the present invention showing lists of links to network profiles;

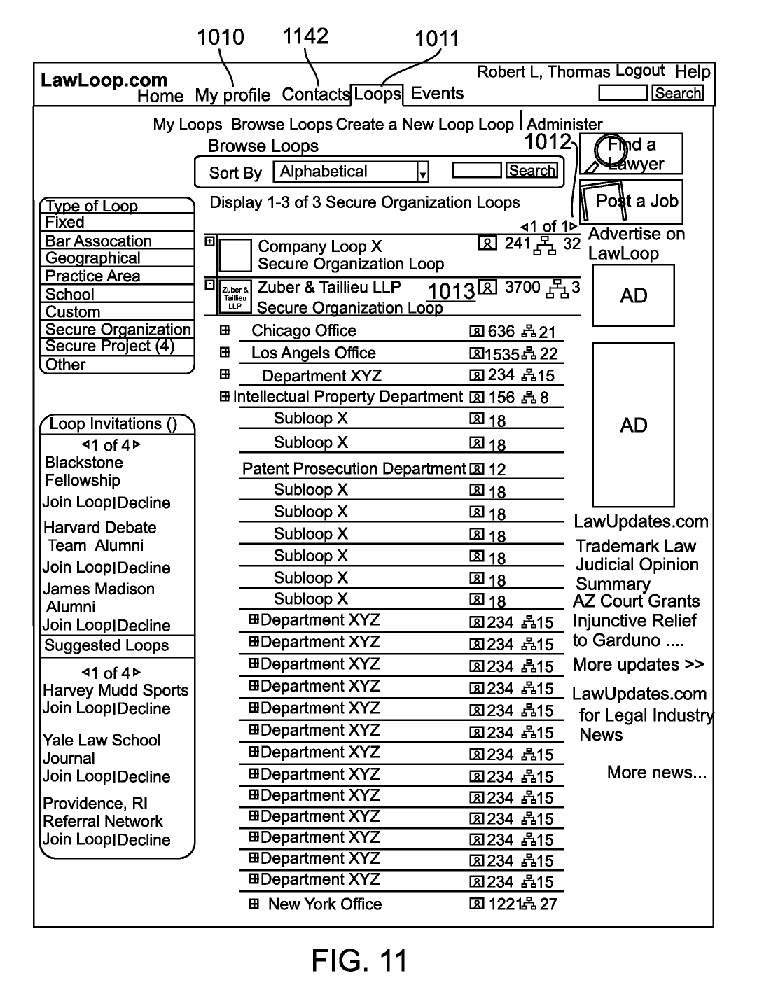

FIG. 12 is an exemplary graphical implementation of another aspect of the present invention showing a network profile;

FIG. 13 is an exemplary graphical implementation of another aspect of the present invention showing a document management tool with a document filing tool and email tool active;

FIG. 14 is an exemplary graphical implementation of another aspect of the present invention showing a document management tool with a document filing tool and word processor tool active;

FIG. 15 is an exemplary graphical implementation of another aspect of the present invention showing a document management tool with a document filing tool and spreadsheet tool active;

FIG. 16 is an exemplary graphical implementation of another aspect of the present invention showing a document management tool with a document filing tool and presentation tool active;

FIG. 17 is an exemplary graphical implementation of another aspect of the present invention showing a document management tool with a document filing tool and image viewing tool active;

FIG. 18 is an exemplary graphical implementation of another aspect of the present invention showing a document management tool with a document filing tool and word processor tool active in a multi-column format; and

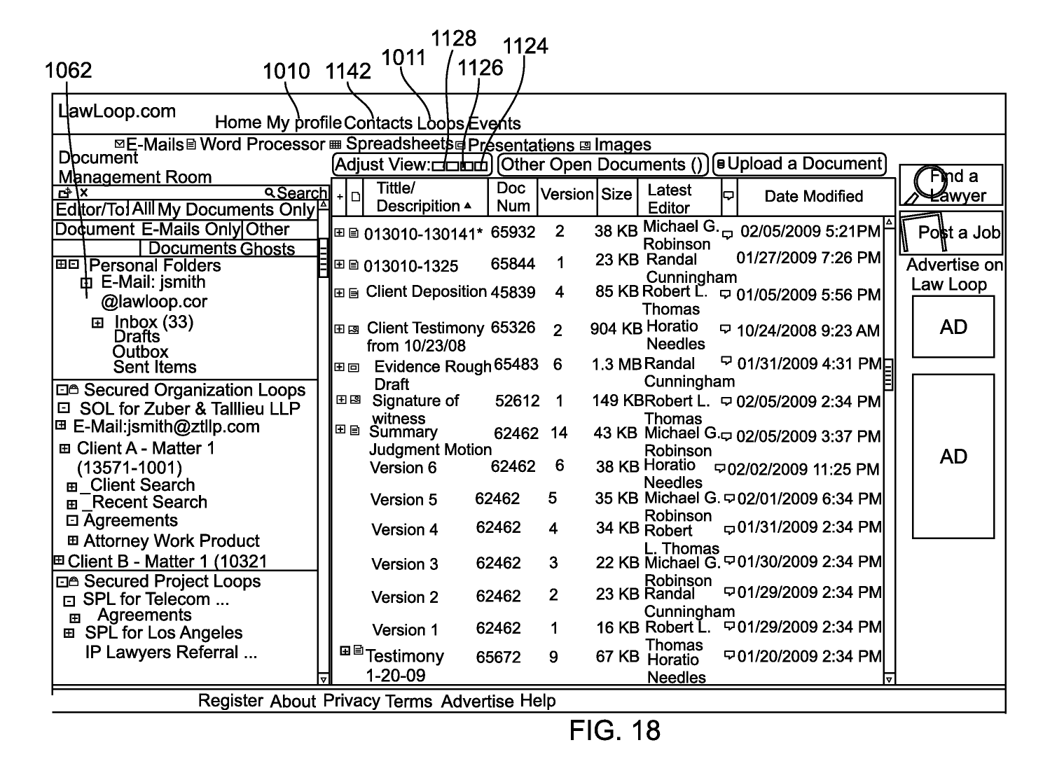

FIG. 19 is an exemplary graphical implementation of another aspect of the present invention showing lists of shared contacts.

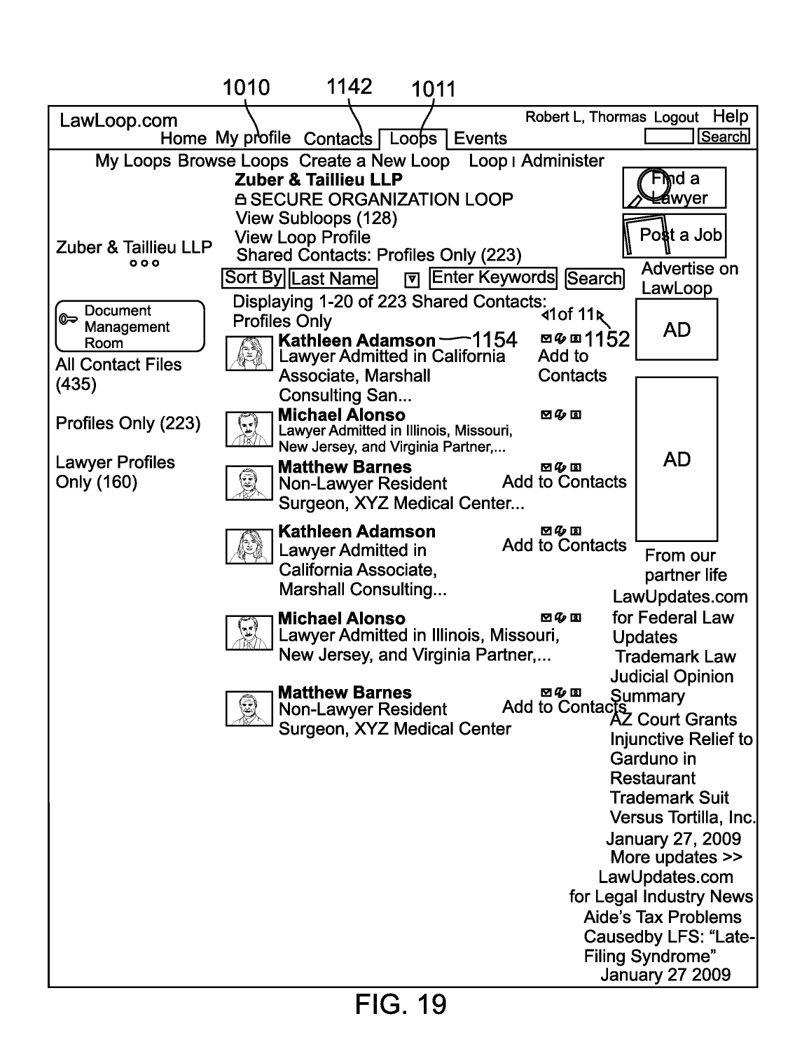

FIG. 20 is an exemplary graphical implementation of the cross-community profile search functionality of the present invention.

### DETAILED DESCRIPTION OF THE INVENTION

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention. Without limiting the generality of the foregoing, some of the descriptions and examples below relate to law firms, and to attorneys, staff persons and clients of law firms, as a matter of convenience, and for the sake of illustration, only; and the present invention may be utilized and practice by other organizations, professionals, entities and/or persons, and such use and practice is contemplated by and included within the scope of the present invention.

The present invention discloses an online social networking community. More particularly, the present invention discloses a system and method for providing the secure, network-based collaborative work environment within the context of the online community, and for providing a means to collaborate across online communities. The present invention further discloses integrative functionalities which lie on top of, and are made possible by, combining social networking functionalities and document management functionalities, within a remote, secure online environment.

Social Networking Functionalities

Members of the online community have an account with the online community which defines a member virtual identity associated with the member. The member virtual identity typically includes web pages that convey information about the member to one or more other members of the community, is enabled with one or more social networking functionalities, and is an online representation of that member that may take many different forms. In regard to each member, participation in the online community typically requires identification verification in order to enable the member's member virtual identity, and therefore means of identifying a member, such as a username, a password, fingerprints, or some other form of identification means relating an identity of a member to his or her member virtual identity, may also be included within the member virtual identity so that a member entering such information can be verified as the owner of the member virtual identity. The member virtual identity allows members to participate in at least one social functionality available within the online community. Alternatively, the member virtual identity may be represented by an icon (“icon” meaning a graphical link, textual link, or other link to a web page or a location on a web page) instead of web pages. Typically, though, a member virtual identity will consist simply of a login account of the relevant member, a web page or a collection of web pages associated with the member (which typically include/s a profile (defined below) of the member and may or may not include additional web pages), and at least one social networking functionality (defined below).

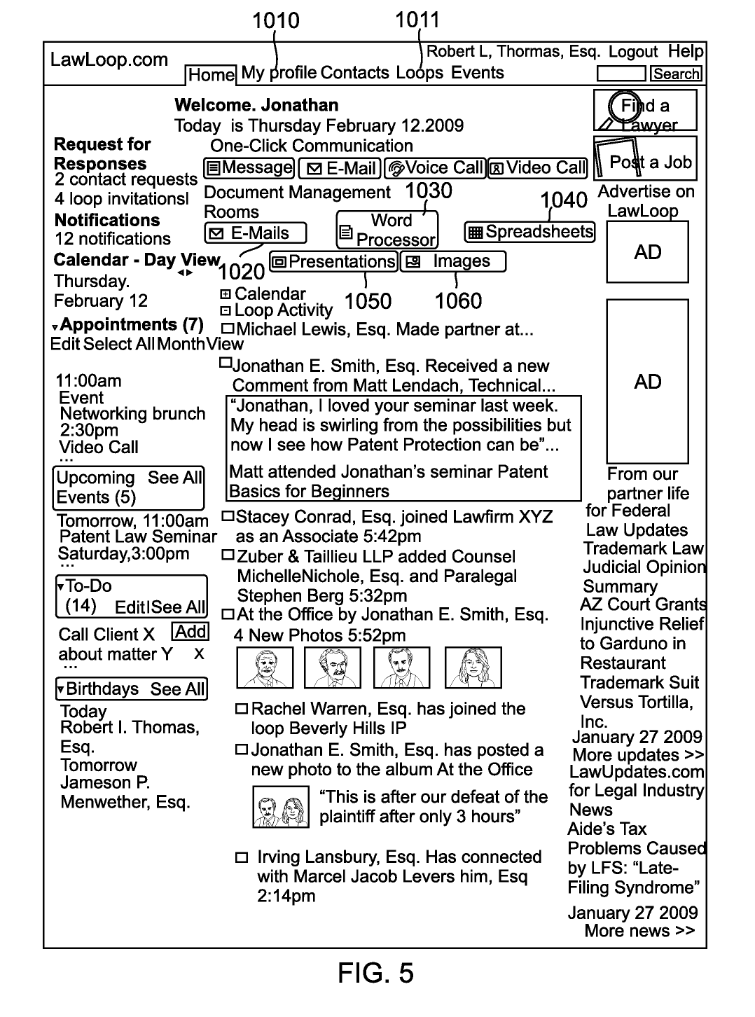

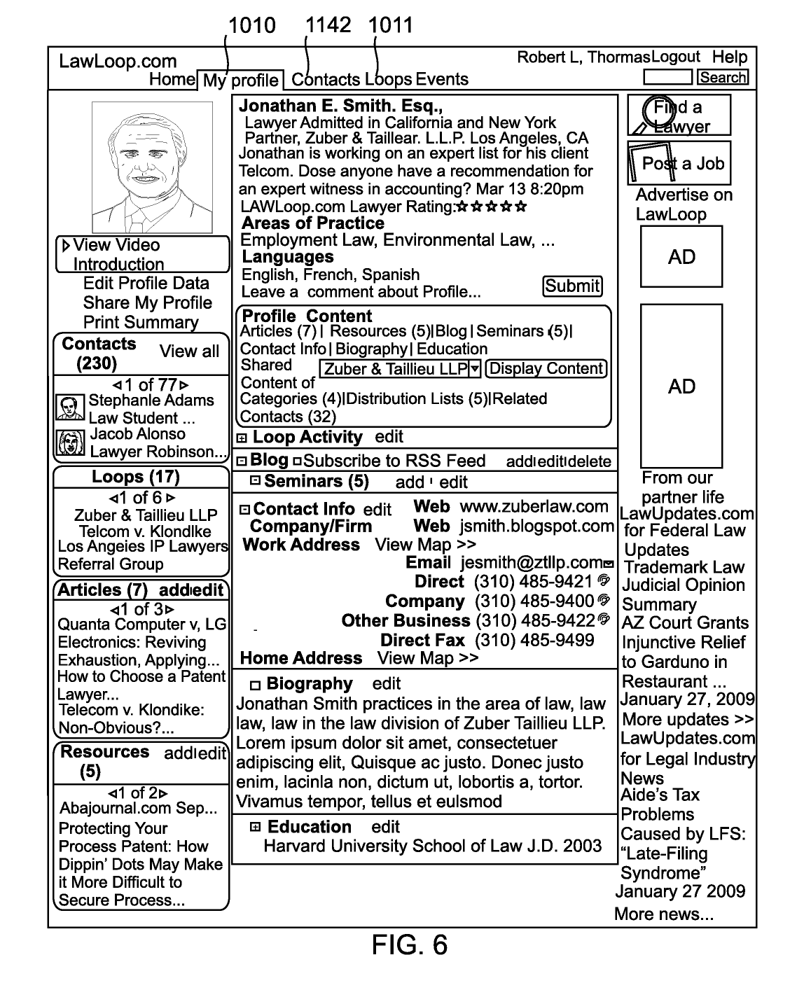

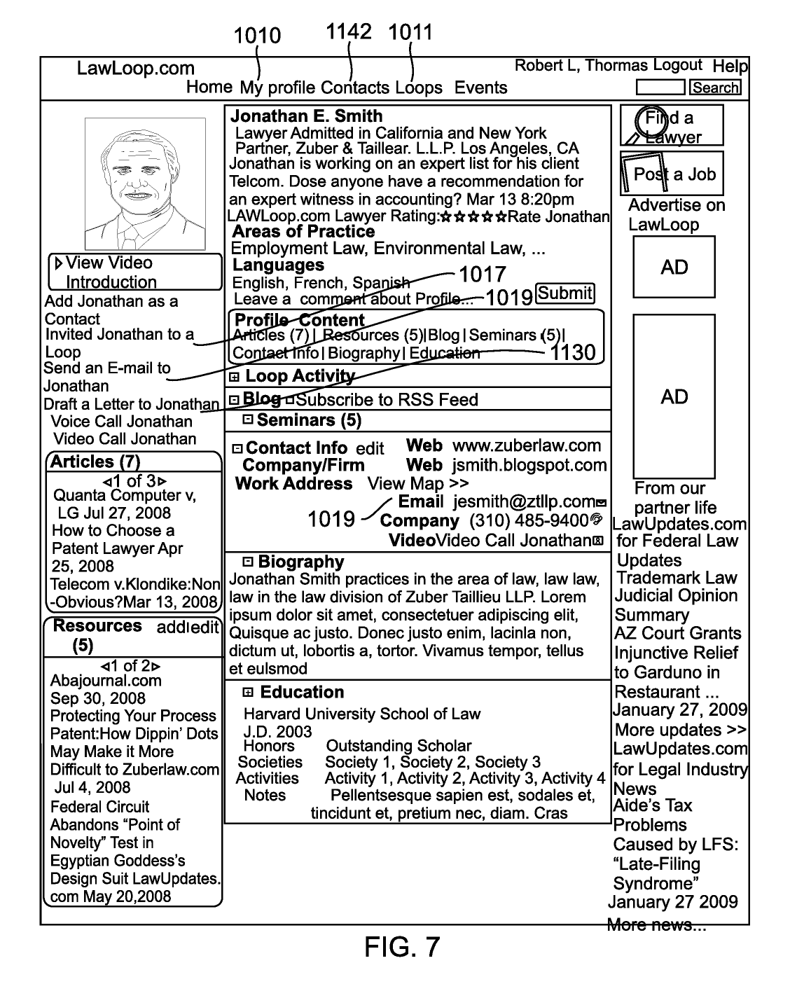

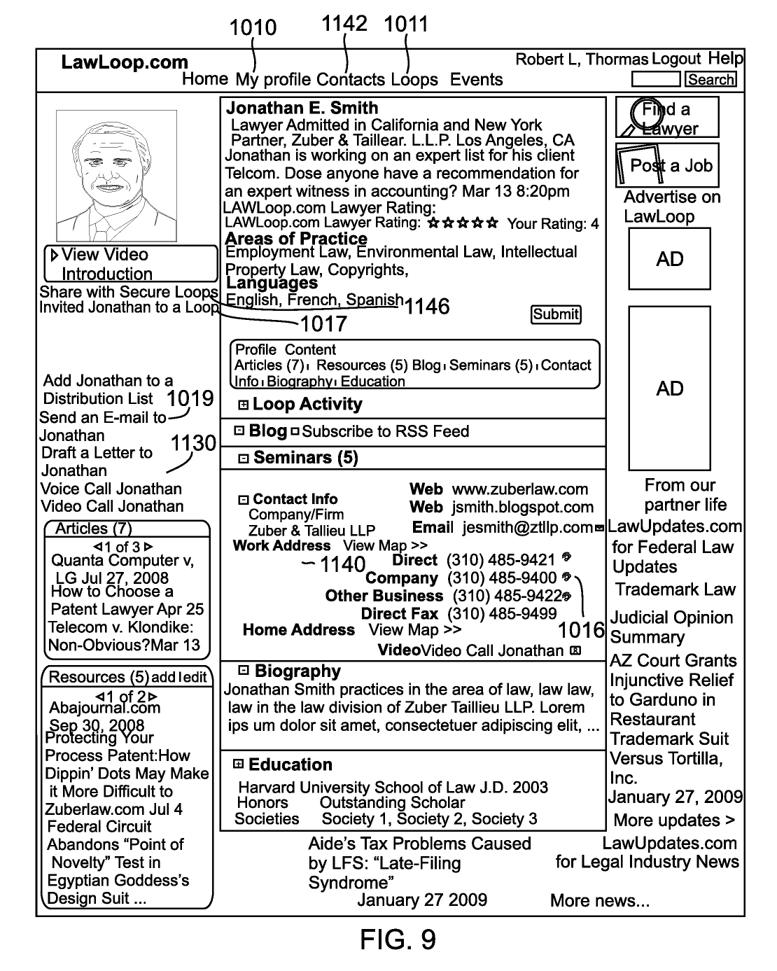

For example, a first member may access his/her member virtual identity by typing in a username and password at a login web page, as a user of social networking websites such as Facebook.com, Myspace.com or LinkedIn.com enters a username and password at a login web page to access his/her member virtual identity. Upon doing so, the web pages of the member's virtual identity appear, starting with a home page such as the web page depicted at FIG. 5 (also referred to herein as “Home Page”) to appear. The member may access his/her profile (profile of a member or “member profile” meaning the web pages of a member's member virtual identity that are partially or wholly visible to one or more other members of the community, often including contact information of the member, such as but not limited to business address, home address, business phone number, home phone number, mobile phone number, business fax number, home fax number, email address, etc., as the term “profile” is commonly understood in the online social networking industry) by clicking on the “My Profile” link at 1010, causing a web page of the profile such as the web page depicted at FIG. 6 (also referred to herein as “Profile—View By Owner,” where “owner” means the first member referenced above to whom the member virtual identity corresponds) to appear. Profile—View By Owner can differ from the versions of the Profile that are visible to one or more other members (i.e.: other than the Owner). For example, members other than the owner who have not been added as contacts (“contact” having a meaning analogous to “friend” on Facebook.com or Myspace.com, or to “connection” on LinkedIn.com, as the term “contact” is commonly understood in the online social networking industry) may see the version of the profile depicted at FIG. 7 (also referred to herein as “Profile—View by Members Who Are Not Contacts”), which might differ from Profile—View By Owner, for example, in that Profile—View By Owner can include links that allow the owner to add, delete or edit content on his/her profile, and the web page depicted in FIG. 9 (also referred to herein as “Profile—View by Members Who Are Contacts” might not; and in that Profile—View by Members Who Are Contacts may include an “Add Jonathan as a Contact” link, while the Profile—View By Owner might not.

The member, being a first member, may add a second member of the community as a contact, whereby the second member would be a contact of the first contact (and vice versa). (“Contact” having a meaning analogous to “friend” on Facebook.com or Myspace.com, or to “connection” on LinkedIn.com, as the term “contact” is commonly understood in the online social networking industry.) Having been added as a contact by the first member, the second member could see the version of the profile depicted at FIG. 9 (Profile—View by Members Who Are Contacts), which can include additional contact information 1016 that is not included in the view available to non-contacts (i.e., the view in FIG. 7).

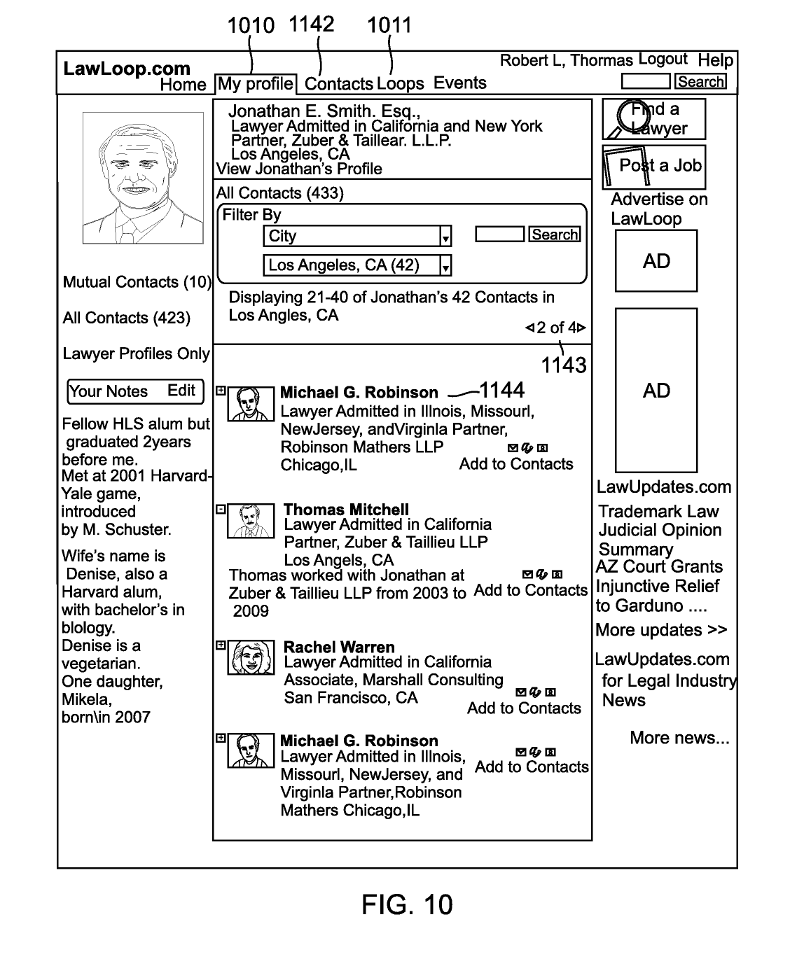

Furthermore, the first member, having logged in via the login account of his/her own virtual identity and accessed his/her own profile, could click on an icon 1142 of his own profile depicted in FIG. 6, thereby causing a web page depicted at FIG. 10 (also referred to herein as “Lists of Contacts”) displaying a list of links to the profiles of all contacts of the second member to appear.

Examples of member virtual identities are widespread in the prior art. For example, online representations consisting of a user's login account, and the user's associated web pages, on social networking websites such as Facebook.com, Myspace.com and LinkedIn.com, are each member virtual identities for the purposes of the present invention.

Members of the online community are capable of assembling into networks and sub-networks. These networks allow members to come together interact with each other via the social networking functionalities. An important feature of the present invention is that networks may be exclusive to certain members but not others, so that networks exclude at least one member in the online community. This allows for a collaborative work environment that provides members with the ability to work together on projects, and to communicate with one another, in situations where some members of the online community cannot or should not participate. For example, lawyers who are members and included with a network or sub-network in which they are working on a set of documents for a client or clients must know that they are not sharing confidential information with members who cannot have access to that confidential information. Therefore, this network or sub-network will exclude other members to protect the confidential nature of the collaboration among members of that network.

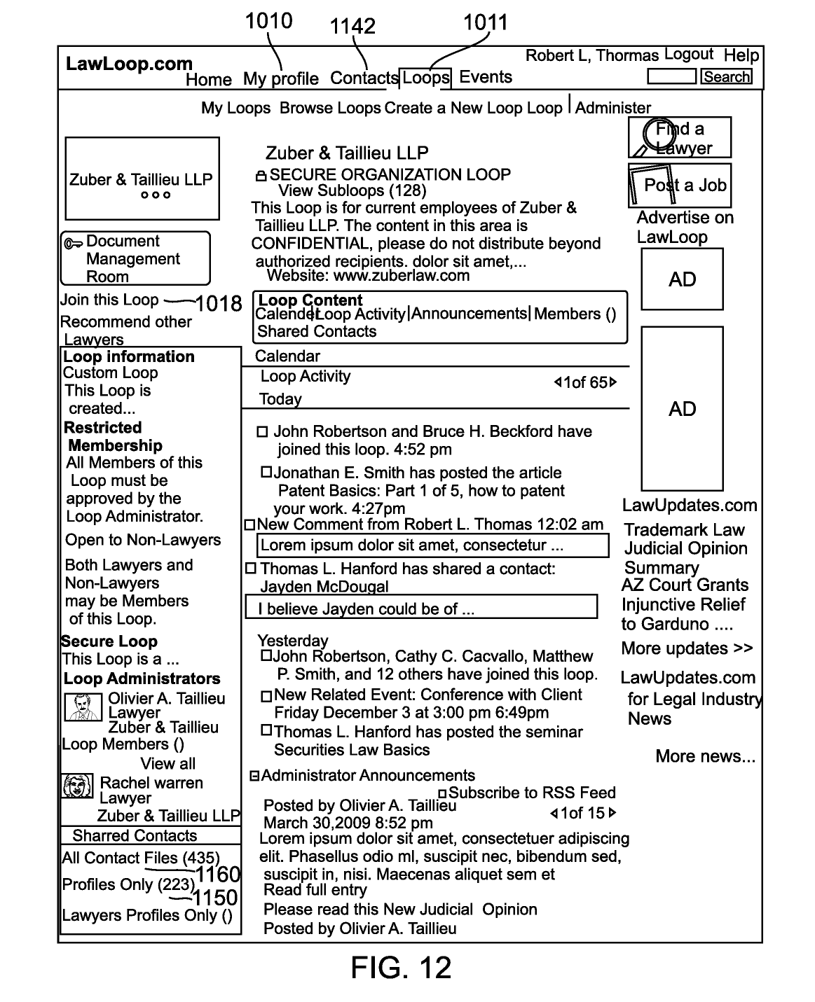

Members may assemble into a network based on a variety of characteristics and via a variety of methods. For example, a network administrator of a network may create and maintain a network, and may “add” members to the network (i.e.: incorporate members into the network), for example, referencing the example above, by clicking the “Invite Jonathan to a Loop” icon 1017 on the member virtual identity at FIG. 7. As another example, a network administrator of a network may invite a member to be added to the network, again referencing the example above, by clicking the “Invite Jonathan to a Loop” icon 1017 on the member virtual identity at FIG. 7, thereby delivering a message (e.g.: via email, electronic message, instant message, or another social networking functionality of the community) to the corresponding member allowing the member to “accept” the invitation (i.e.: to effect the add and thereby become a member of the network), for example, by clicking on a link within the message. As another example, a non-member of a network may request to join the network by clicking on an icon 1018 on the network virtual identity of the network at FIG. 12, thereby delivering a message (e.g.: via email, electronic message, instant message, or another social networking functionality of the community) to the network administrator of the network allowing the network administrator to “accept” the request (i.e.: to effect the add and thereby make the requestor a member of the network), for example, by clicking on a link within the message.

Exclusion from a network may be achieved in a variety of different ways. For example, exclusion from a network may be achieved by a network administrator's refusal to add a member to a network, refusal to accept a member's request to be added to the network, or “removal” of a member (i.e.: a revoking of a member's membership in the network) previously added to the network. Any other means of including or excluding members from participating in a network or sub-network are also contemplated by and included within the scope of the present invention. Of course, a member may also effect non-membership in the network by refusing to request addition to the network, refusing to accept an invitation to join the network by a network administrator of the network, or by removing himself/herself from the network.

Other social networking functionalities are also available to members in the online collaborative work environment. The social networking functionalities are available to members remotely (for instance, social networking functions enabled by software saved to servers remote from the members that allow members to manage virtual profiles and other web pages and aspects of the collaborative work environment saved on servers remote from the members). Examples of social networking functionalities include real-time communication functions that allow members (including, in particular, professionals who require communication functions in the course of collaborating within the present invention) to quickly and efficiently communicate with each other. These communication functions include, but are not limited to, on-line video conferencing, on-line voice conferencing, emailing, on-line messaging, instant messaging, text messaging, calendaring, and message posting. All of these occur in the context of the collaborative work environment and may occur within one or more networks, particularly where confidential information is being discussed and where one or members are excluded from the network.

Specific examples of the use of social networking functionalities within the networks and sub-networks of members include the use of calendaring and message posting systems. Social networking functionalities may be shared among members within one network, but not shared among members of a sub-network, so that activities within a sub-network are not activities within the broader network. For example, one social networking functionality is a calendaring system. The present invention contemplates that one calendaring system (or, set of occurrences) may be used within a network. Within a sub-network of that network, a second calendaring system (or set of occurrences) may be used in which entirely different events are used.

Similarly, a message posting system is a social networking functionality in which messages posted in a first network (or sub-network) are not included in a second network (or sub-network). Members of a network may “break off” to assemble in a sub-network and post different messages that do not have utility in the main network and may not be viewable or accessible in the main network. It is important to note, as above, that the sub-network may exclude a member of the network of members and that posted messages in the sub-network may not be accessible to those excluded therefrom. Message may include any method of conveying a message, and may occur on any type of forum or medium.

Further social networking functionalities are also subject to the same principles, so that members of sub-networks can freely assemble to communicate and/or collaborate separate from a main network to which they are members, and can exclude members. Other examples include but are not limited to emailing systems, instant messaging systems, and video conferencing systems.

Other details, aspects and functions of social networking functionalities, including but not limited to those relating to the addition and removal of contacts, the creation and maintenance of online social networks by network administrators, and the addition and removal of members of online social networks, are thoroughly disclosed in the prior art, and these disclosures and are incorporated herein by reference.

Cross-Community Functionalities

Members of each community are also able to collaborate with members of other communities. Within this document, the term “community” or “social networking community” is used to represent the highest level of online organization. When applied to the prior art, a “community” or “social networking community” would be, for example, LinkedIn.com, Facebook.com, or MySpace.com. Each of these organizations allows members to create a profile and interact with each other member of the community. Within this document the term “network” or “secure network” refers to a sub-group found within a community or social networking community. Applied to the prior art, a network or secure network might be a set of members of MySpace.com who choose to join (or are invited to join) a fan club for the Beatles, for example.

More suited to this invention, an example of a “community” or “social networking community” would be the community of lawyers or members of the legal profession, who created a profile and joined the law community. As an example, such a community might exist at a website www.LawLoop.com. A “network” or “secure network” within a law community would be, for example, members of a particular law firm, members of a bar association, or even alumni from a particular law school. A member profile would be associated with one community, but that same profile would typically be associated with several different networks within the community. The law community would typically have a graphical user interface, or “GUI” that is particularly adapted to the needs of that profession, and that is visually identifiable as belonging to a particular community.

As used throughout this application, the term “particularly adapted” is intended to mean that an application, interface, folder, template, etc. is not merely a general-use item, but is more narrowly tailored to meet the needs of a particular subset of consumers, such as a specific profession or group of professions. For example, a general purpose word processing program would not be “particularly adapted” to the legal community (although it would be used extensively throughout the community) because it is also commonly used by all types of people, without regard to profession or task. By contrast, Concordance® discovery management software (familiar to most members of the legal profession) would be an example of an application that is “particularly adapted” to the legal community, as it offers services tailored to the needs of legal professionals engaged in a particular task (i.e., discovery and document review). Similarly, advertisements, document folders, document templates, and user interfaces are “particularly adapted” to a particular community when they are customized to meet the needs of the profession or community. More detailed descriptions of such “particularly adapted” items are included throughout this application.

Other communities are contemplated by this invention. In a preferred embodiment, each community would be established at an online location that references the profession served by the community. For example, a community of doctors and other medical professionals would form a medical community, perhaps at the website www.MedicineLoop.com. Each member of that community would be able to interact freely with each other member of that medical community, typically (but not necessarily) joining one or more networks within the medical community. It is contemplated that many other professions would each have a community of its own. Each community would have a GUI particularly adapted to the needs of its members. Typically, each community's GUI would be visually distinct from each other community's GUI.

An alternative embodiment of this invention is a community wherein a member could be a member of more than one community, and would be able to switch between a first community and a second community, and so on. For example, a lawyer might also become a member of the medical profession. That lawyer, who already has a law community profile, may also wish to have a profile in the medical community. Rather than re-create his entire profile, the lawyer-doctor of this example would be able to alternate back and forth between communities as he wishes. In this example, the lawyer-doctor member would view a default GUI (the law community GUI, for example) upon entering the community, but would be able to alternate between other GUIs (e.g., the medical community GUI). In a preferred embodiment, the member's GUI would transform to the second GUI upon entering the second community, without the need to log-in or refresh the GUI.

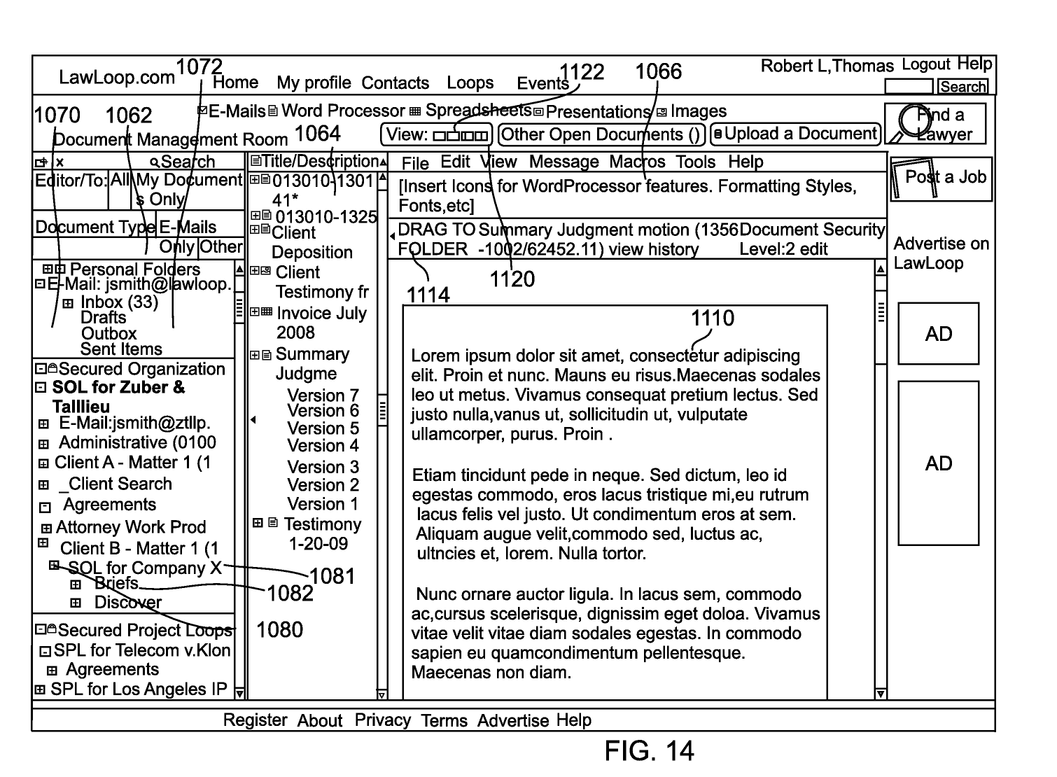

As another example, a member of the law community may begin working in the government sector. In that case, the government community GUI might be more useful in this new position. The government lawyer member would then be allowed to choose to associate with the community (law or government) that is deemed most useful to that member, along with the associated GUI that is particularly adapted to the chosen industry. By so doing, the member is able to participate in that community which offers applications, functionalities and interfaces that are more useful to the member's chosen industry. The ability to select a GUI particularly adapted to a profession is discussed in further detail below with reference to FIG. 14.

One advantage of being a member of a community (and networks within the community) is the availability of collaborative social networking functionalities. Members can create, edit, and share work product with members of the networks within the community. For example, members of a network can collaborate on documents using the document management functionalities described herein. Alternatively, members of a network can share contacts with other members of a network. Thus, members of a community can collaborate with one another, taking advantage of the compatibility and ease of communication afforded by the community.

It is often the case that members of one profession need to interact with members of another profession. One way to do this in the context of a social networking community is to force each member to join each new community in order to interact with members of that community. For example, a member using a member profile from MySpace.com could not become a “friend” on another person's Facebook page. Instead, the first person would have to create a Facebook profile and join the second person's Facebook page using the newly-created Facebook profile. A better way to do this is to allow a member profile from one community to interact across communities without creating any new or additional profiles for any of the members.

To picture this, imagine a law community as described above (“Law Community”) and a medical community (“Medical Community”) as described above. An attorney who is a member of the Law Community has created a profile in the Law Community, and has typically joined several networks within the community, including a network for his own law firm. Imagine that the attorney then begins work on a case that requires the services of a doctor who acts as an expert witness. The doctor, in turn, is already a member of the Medical Community, and has created his own profile and is typically a member of one or more networks within the Medical Community.

It is an object of this invention to allow the doctor and the lawyer in this example to take advantage of compatible social networking functionalities of each professional's respective community. For example, the lawyer may wish to share a brief or court filing with the doctor/expert witness. According to this invention, the lawyer could invite the doctor to join the lawyer's network—for example a special network just for lawyers working on the case. The invitation would be sent to the doctor's Medical Community profile. The doctor, logging in to the Medical Community, would accept the invitation, thereby joining that particular network within the Law Community. No additional registrations or profiles would be necessary for either the doctor or the lawyer. The doctor would be able to access documents created and managed using the document management tools available in the Law Community, to share contacts with the members of the network within the Law Community, or to take part in any other activity that is available to members of the particular Law Community network that the doctor has now joined.

Another advantage of this invention is that it allows large organizations with a diverse group of employees to interact with each other, while typically viewing the GUI that it most useful to their own profession. For example, a large hospital might have several hundred doctors who would be members of the medical community of this invention. That same hospital might also employ several in-house attorneys who would be members of the legal community. The hospital might also employ several accounting professionals who would be members of the accounting or financial community. Each group of employees would be able to interact with each other group of employees, notwithstanding that each group has its own GUI with the attendant tools, applications, and folder sets that are particularly adapted to their own profession.

Another object of this invention is to facilitate member profile searches across communities. Continuing the example above, the lawyer may wish to connect with a doctor who may or may not be a member of the Law Community. According to the present invention, the lawyer would be able to use the member profile search function of the law community to search through each other compatible community for the doctor.

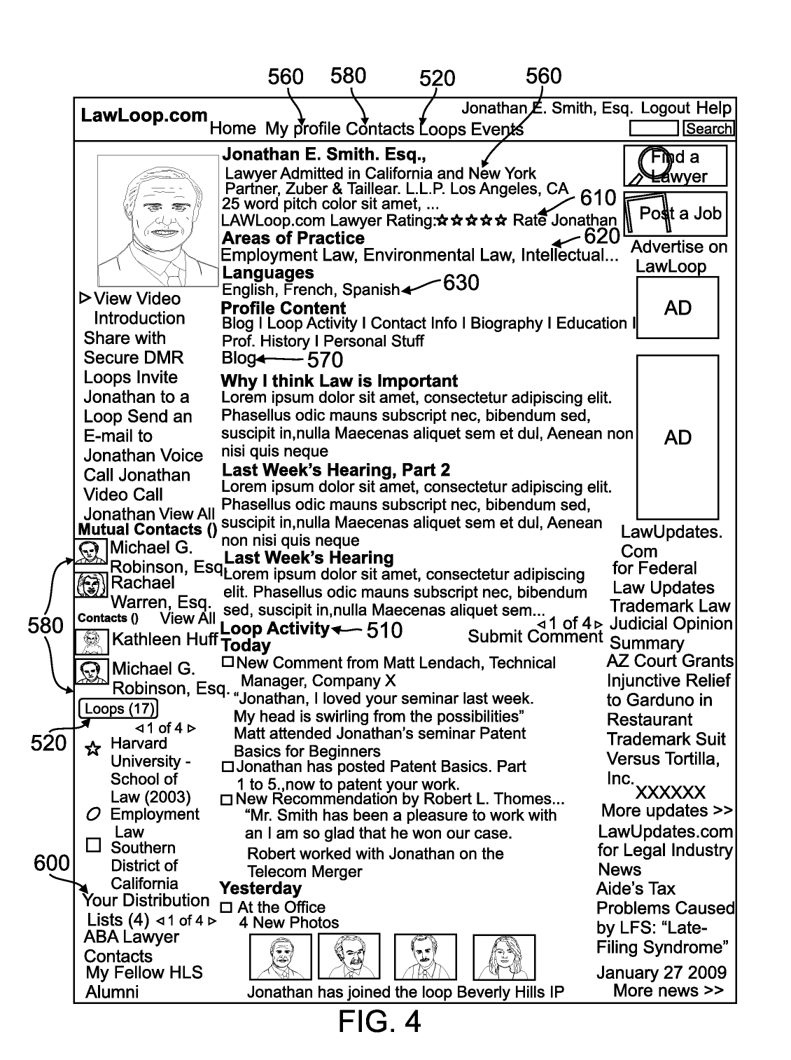

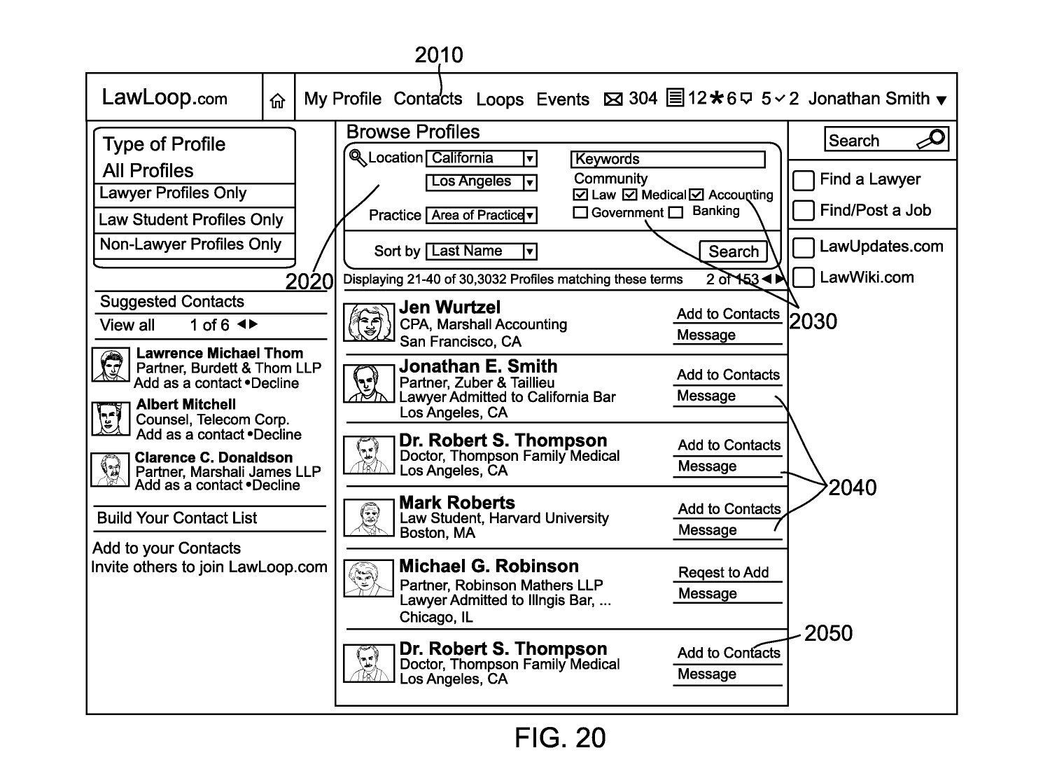

In the preferred embodiment, as shown in FIG. 20, the lawyer would begin the cross-community profile search by selecting the contacts file management tool 2010 (which corresponds to the contacts file management tool 580 and 1142 as shown in FIGS. 4 and 6, respectively) from the lawyer's home page or from any other page displaying the contact file management tool within the Law Community. The member is then presented with the option to browse or search profiles as shown in FIG. 20. The Browse Profiles tool 2020 allows the member to search for profiles by keyword such as name, profession, or other some other identifying characteristic.

As shown in FIG. 20, the member using the preferred embodiment is able to indicate which of the existing communities he would like to search, using selection buttons 2030. The member may choose to select only within the Law Community, or within all communities or only within some of the communities, according to the needs of the member. In the example shown, the member has selected to search through the Law Community, the Medical Community, and the Accounting Community for the name of the doctor, while excluding from the search the Government Community and the Banking Community. Profiles that match or potentially match the information entered would preferably populate in a list 2040 below the search box in the embodiment shown. In an alternative embodiment, the list of potential matches would appear in a new window. The member would then be able to choose to add the doctor as a contact by clicking on the “Add to Contacts” button 2050 next to the appropriate profile in the example shown.

The embodiment shown in FIG. 20 is the best mode currently contemplated for this aspect of the invention. A person of skill in the art would recognize that there are other possible methods for arranging aspects of this embodiment. For example, communities might be selected using a drop-down menu or other means for selecting multiple options, instead of using selection boxes. Other variations in keeping with this invention are contemplated although not specifically enumerated herein.

Another aspect of this invention is that it allows individuals who would not ordinarily be members of a particular community to participate in and take advantage of certain aspects of a community. In one embodiment of the invention, for example, a law firm might wish to provide access to a particular network to a client associated with that network, even though the client otherwise is not be a member of the legal community. The non-lawyer client would be allowed to create a profile (or have a profile created on behalf of the client) in order to interact with certain aspects of the network related to the client's case. Similarly, a doctor might create a virtual identity for his patients, such that all charts, diagnoses, etc., are associated with a particular individual who has his or her own presence within the medical community as a patient.

This ability to create client or patient virtual identities is particularly useful in that it would also allow the professional members to easily track the client/patient and to transfer files belonging to the client/patient should the need arise. For example, a patient who moves from California to Virgina would simply associate his patient virtual identity to his new doctor in Virginia, which would allow the new doctor easy access to records maintained within the medical community and associated with the patient.

Document Management Functionalities

Document management functionalities are also available to members in the collaborative work environment. One example of a document management functionality is the ability to create documents (i.e.: “document” meaning an email, a word processing document (e.g.: a letter, a fax), a spreadsheet, a presentation (e.g.: a Power Point® presentation), an image (e.g.: an Adobe Acrobat® image, a digital photograph), or any other type of document as the term “document” is used in the software application industry). Another example of a document management functionality is the ability to edit documents. Other examples of a document management functionality are the ability to delete documents, to save documents, to organize documents, to file documents, to access documents, to send documents, to receive documents, and to share documents.

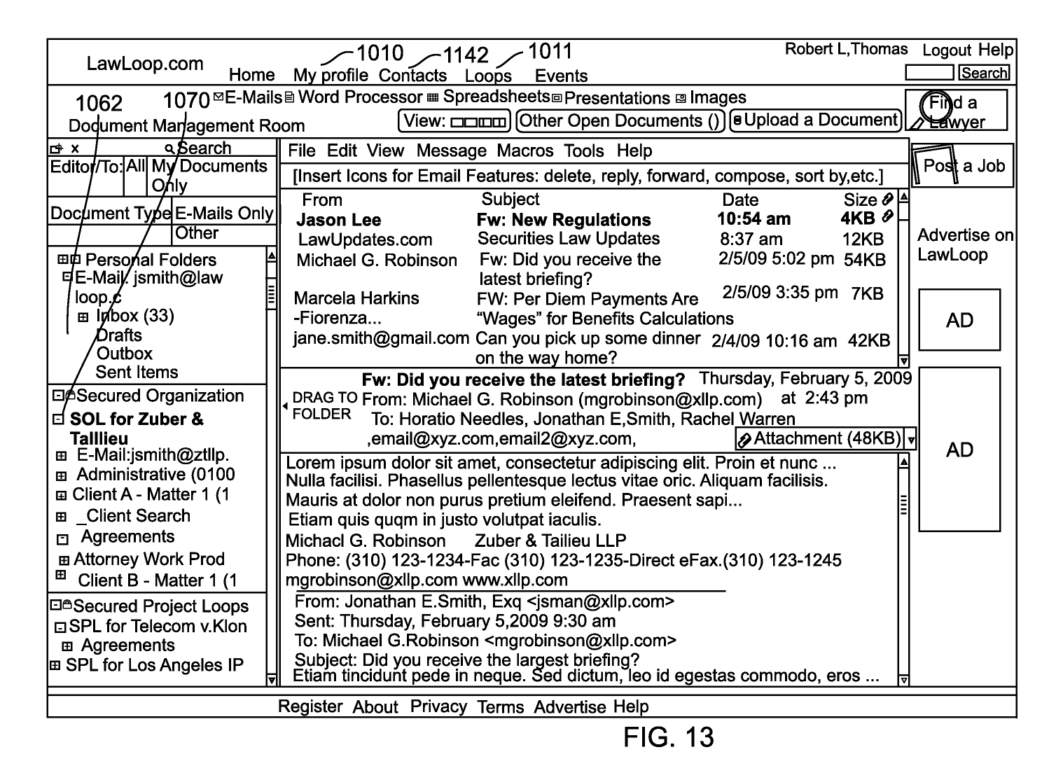

The document management functionalities are accessible to members via a document management tool that allows members to remotely and securely manage (i.e.: “manage” means to create, edit, delete, save, organize, file, access, send, receive, and/or share) documents. The document management tool comprises online software applications available to members that allow members to manage documents remotely (for instance, software applications saved on servers remote from the member that allow the members to manage documents saved on servers remote from the members), including a calendaring tool such as Outlook®, an email tool like Outlook® or Zoho® Mail, a word processing tool such as Word® or Zoho® Writer, a spread sheet tool such as Excel® or Zoho® Sheet, a presentation tool such as Power Point or Zoho® Show, an image viewing tool such as Adobe Acrobat®, a document filing tool like Interwoven® or Zoho® Docs, and/or a contact file management tool such as Outlook® (“contact file” meaning a file containing/storing contact information, but not being associated with a virtual identity, as such term “contact file” is commonly understood in the contact file management software application industry). The document management tool allows a member to access, work with, and manage a system of windows (i.e.: “window” meaning a portion of a computer monitor screen typically wholly or partially separated from other portions of the screen by a graphic border or other means) and folders for managing documents, such as the document management tool depicted at FIG. 13.

A member described in the example above who accessed his/her virtual identity by typing in a username and password at a login web page could access the document management tool from his/her Home Page by clicking on any of the link 1020, the link 1030, the link 1040, the link 1050 or the link 1060. For example, the member could click on the “Emails” link at 1020, causing a document management tool like the one depicted at FIG. 13, to become active, 525 wherein a document filing tool and an email tool are active.

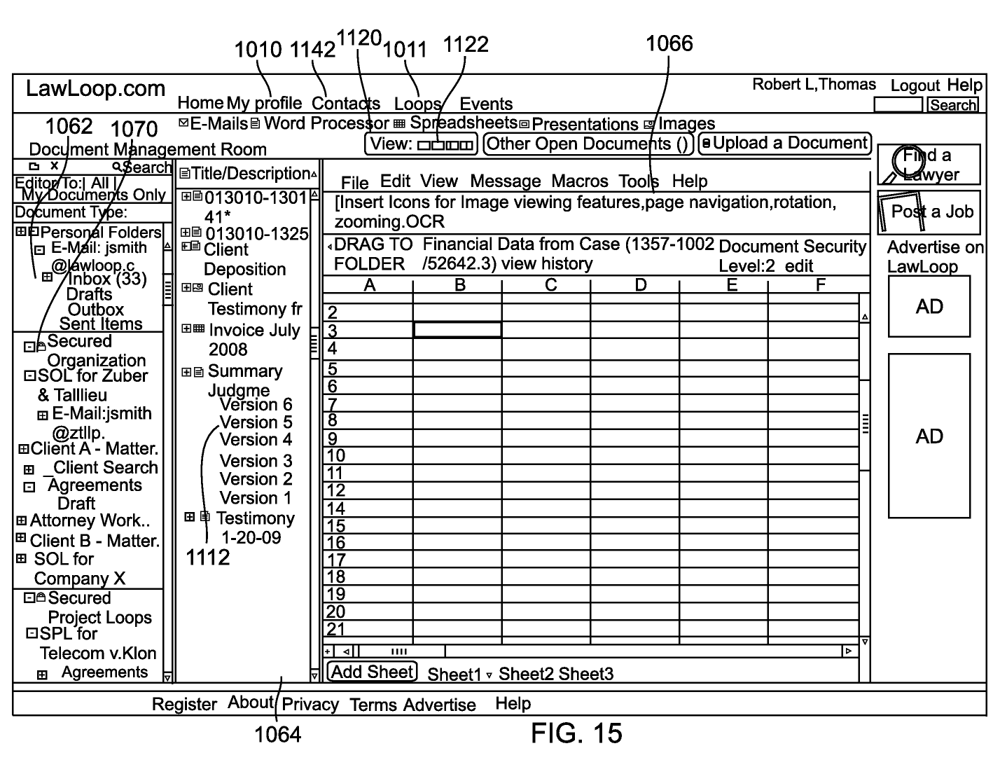

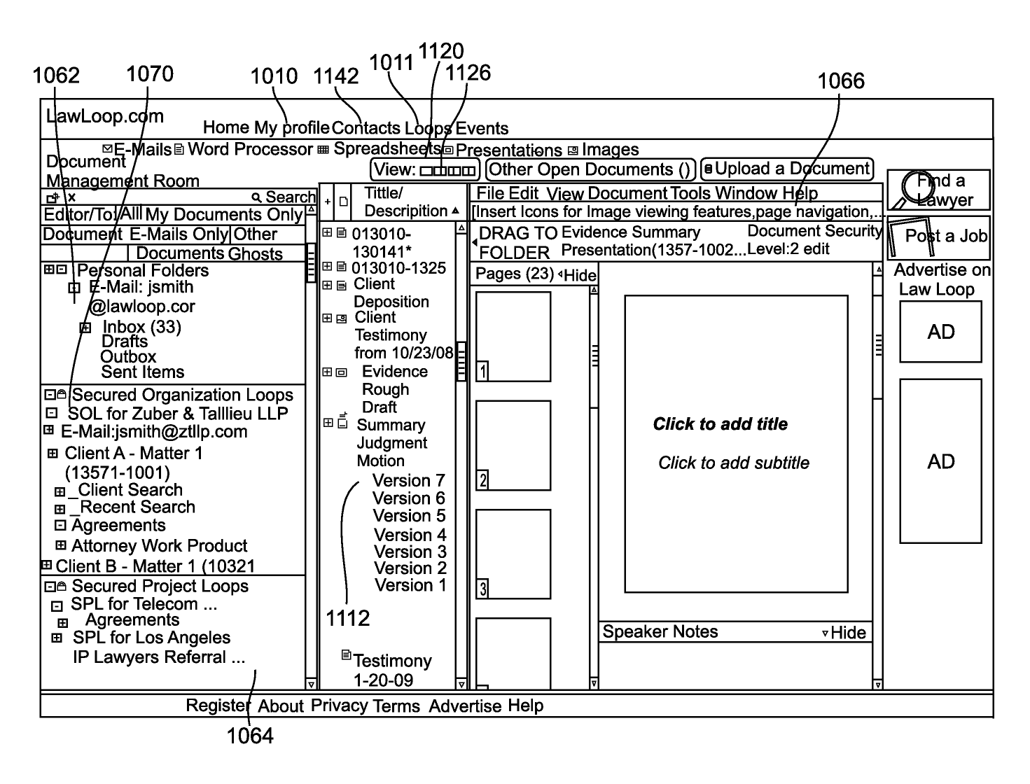

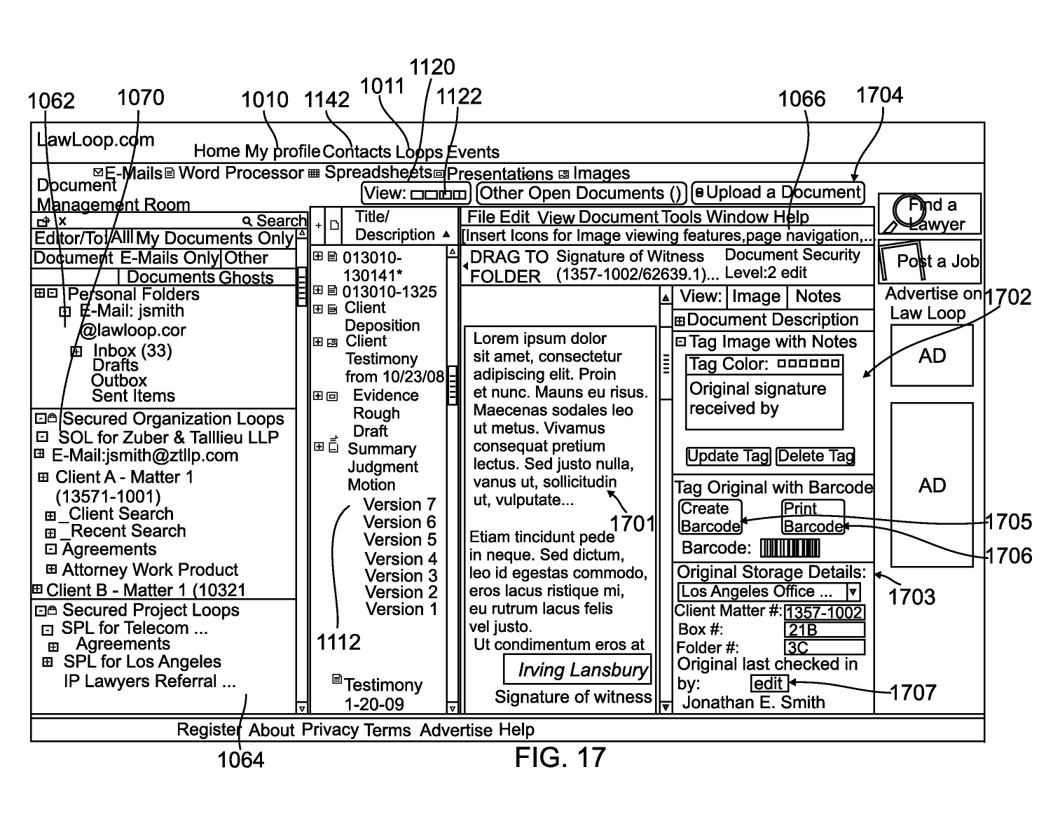

As another example, the member could click on the “Word Processor” link 1030, causing a document management tool like the one depicted at FIG. 14, to become active, wherein a document filing tool and a word processing tool are active. As another example, the member could click on the “Spreadsheets” link 1040, causing a document management tool like the one depicted at FIG. 15, to become active, wherein a document filing tool and a spreadsheet tool are active. As another example, the member could click on the “Presentations” link 1050, causing a document management tool like the one depicted at FIG. 16, to become active, wherein a document filing tool and a presentation tool are active. As another example, the member could click on the “Images” link 1060, causing a document management tool like the one depicted at FIG. 17, to become active, wherein a document filing tool and an image viewing tool are active.

Other details and aspects of these document management functionalities, and these software applications, are thoroughly disclosed and enabled in the prior art, and these disclosures are incorporated herein by reference.

Like other aspects and functionalities described herein, the document management functionalities of the invention are preferably adapted to the particular needs of each community. As described below, each community would preferable have a unique graphical user interface with a set of document management folder particularly adapted to that community.

Another aspect of the document management functionalities being particularly adapted to each community is that the members are able to access document templates or macros that are tailored to the particular industry to which the member belongs. For example, a member of the law community would have access to document templates that are particularly adapted to a lawyer. A more focused example of this would be a contract template, whereby the lawyer/member would be asked for certain information about the parties to the contract upon creation of the document. The member would input, for example, the name of a licensor and a licensee, the effective date of the contract, a description of the subject matter of the contract, and so on. The member would preferable also be presented with a list of optional language to include in the contract. An example of these options would include paragraphs that describe particular legal concepts that are to be addressed in the contract, but that are nevertheless sufficiently standardized within the industry to allow them to be imported without change. Provisions such as a so-called “zipper clause,” a “force majeur” provision, are just two examples of this type of insert-ready language.

Another example of a template would be the creation of pleading documents for litigation. The member would be asked for pertinent case information at the beginning of a case, such as the names of the parties, the jurisdiction, case number, and judge name. Thereafter, the attorney would be able to select from the template or macro application to use the template for that case, thereby saving time re-creating the case caption each time a document is created. Similarly, the member would be able to more easily create court filings, discovery, and other standard documents. In the case of written interrogatories to a party, the lawyer would likely have a standard set of instructions that he often or always includes with his interrogatories. By using the template application described herein, the lawyer would be freed from re-typing pages of instructions; instead, the lawyer would merely specify the type of document (e.g., special interrogatories) and complete a few additional fields, such as the responding party's name, and which instructions he would like to include. The template application would thereafter create the document or document shell for the member.

Similar template applications would be available to members of other communities. For example, a member of a medical community would have available to him or her a set of templates that are particularly adapted to medical professionals, such as a patient chart, letters to remind patients of upcoming procedures, and so on.

Integrative Functionalities

The online collaborative work environment of the present invention offers several integrative functionalities that overlay and are made possible by the combination of various social networking functionalities and document management functionalities. Integrative functionalities provide the mechanism for performing tasks within the collaborative work environment. These integrative functionalities allow members to collaborate within specific modules to work on projects together more easily, efficiently and effectively. Integrative functionalities allow members to manage (i.e.: “manage” meaning to create, edit, delete, save, organize, file, access, send, receive, and/or share) documents within a secure document management system more easily, efficiently and effectively.

Among the integrative functionalities is the ability for members to easily assemble in a network remotely sharing a document or group of documents or a “room” (i.e.: “room” meaning a group of folders of documents, as the term “folder” is commonly understood in the industry in the context of document filing systems such as Interwoven®), typically stored on a server at a location remote from at least one (and typically most or all) of the members of the network. More particularly, a network administrator can create a network of members, each having member virtual identities, in accordance with the disclosures above, or in accordance with other means for forming networks on social networking websites such as Facebook.com, Myspace.com or LinkedIn.com. This integrative functionality of the present invention allows this network of members to easily, efficiently and securely share a room of folders of documents.

For example, FIG. 14 shows a window 1062 displaying rooms of folders of documents including a room 1070 of folders of documents, which room 1070 is the folder 1072 and all of its subfolders, a window 1064 displaying links to documents stored in a folder 1100, which folder is stored in Room 1070 labeled “SOL of Zuber & Taillieu LLP,” and a window 1066 displaying the contents of document 1110 linked to by document link 1112. A member of the network may view the contents of any other document stored in folder 1100 by clicking the corresponding document link in window 1064, thereby causing the contents of the corresponding document to appear in window 1066. Similarly, a member of the network may view the contents of any other folder of room 1070 by clicking on the folder, thereby causing the document links to documents stored in the folder to appear in window 1064.

In one embodiment, the present invention contemplates a network of members comprising the attorneys and staff persons of a law firm, the network sharing a secure room 1070 of folders of documents of the law firm (i.e.: “secure” meaning that members and other persons who are not members of the network do not have access (or as complete access) to the room). Upon the hiring of a new attorney who is a member of the online social networking community, this integrative functionality allows the network administrator to grant the attorney the ability to use the document management functionalities described above to manage the room 1070 by simply adding the attorney to the network by, for example, simply clicking on an “Invite Jonathan to a Loop” icon 1017 on the attorney's member virtual identity at FIG. 7. Of course, this integrative functionality makes possible enormous efficiencies for the law firm. For example, referencing the foregoing example, the law firm added the newly hired attorney above without the need to incur the significant labor and capital costs typically associated with granting such a newly hired attorney access to, say, a secure server containing the documents shared by the law firm, such as, for example, the hours that it would have taken for technical personnel of the law firm to install on the attorney's computer the software applications required to allow the attorney to access the server and manage the documents. As another example, the law firm avoided the need to create a new login account for the newly hired attorney—rather, upon addition to the network, the newly hired attorney, by accessing the login account associated with his/her member virtual identity, has access to the online room 1070 shared by the network. Much as the receptionist at the entrance to the physical premises of the law firm recognizes the physicality of the attorney and grants him/her access to the physical premises, the network administrator recognizes the attorney's online member virtual identity, and grants the member virtual identity (and thereby the attorney) access to the online room 1070 shared by the network by simply adding the attorney to the network by, for example, simply clicking the “Invite Jonathan to a Loop” icon 1017 on the attorney's member virtual identity FIG. 7.

A further integrative functionality allows a member to share a first secure room of folders of documents with a first network of members and a second secure room of folders of documents with a second network of members with a single login account. For instance, referencing the example of the immediately preceding paragraph, the newly hired attorney who has been added to the law firm's network, being a first attorney, may be working on a litigation with a second attorney in the representation of a single client having a member virtual identity, and may wish to share one or more documents and/or folders with the second attorney having a member virtual identity and the client.

Referencing FIG. 14, the law firm network being a first network, a second network administrator of a second network sharing a second secure room 1080 of folders of documents, which room 1080 is the folder and all of its subfolders, could add the first attorney, the second attorney, and the client to the second network, thereby giving the first attorney, the second attorney, and the client access to the second secure room of folders of documents.

The first attorney, by accessing the login account of his/her member virtual identity, can, for example, manage document 1110, being a first document, of the first network by, for instance, accessing the documents of a folder 1100, being a first folder, shared by the first network and containing document 1110 by clicking on folder 1100, then accessing the contents of document 1110 by clicking on document link 1112, and then editing or otherwise managing the document; and may similarly, for example, manage a second document shared by the second network by, for instance, clicking on a second folder 1082 of room 1080 containing the second document, thereby causing documents links to the documents stored in the second folder (again, which folder of room 1080 is shared by the second network and not by the first network) to appear in window 1064, clicking on the document link to the second document to cause the contents of the second document to appear in window 1066, and then editing or otherwise managing the second document (such clicking, accessing, editing and managing in each instance above in accordance with methods already disclosed and enabled in the prior art in the context of, for example, document filing tools such as Interwoven® and word processing tools such as Word® and Zoho Writer®, which disclosures are incorporated herein by reference).

A further integrative functionality is a document sharing tool allowing a member to copy or move a document or documents from a room shared by members of a network to a different room shared by members of a different network. For example, referencing the examples of the immediately preceding paragraphs, and FIG. 14, wherein window 1064 displays the document links to the documents stored in folder 1100 (again, which folder of room 1070 is shared by the members of the first network and not the second network), and window 1066 displays the contents of document 1110 linked to by document link 1112, a member who is a member of both the first network and the second network may “click and drag” document 1110 from folder 1100 of room 1070 shared by the members of the first network to folder 1082 of room 1080 shared by the second network, such that document 1110 is stored in both folder 1100 and folder 1082. Of course, the present invention also contemplates that such clicking and dragging could result in the document being moved (as opposed to copied) to folder 1082 such that, after such moving, it is no longer stored in folder 1100.

A further integrative functionality is another document sharing tool allowing a member to copy or move a document or documents from a room shared by members of a network to a different room shared by members of a different network. For example, a member who is a member of both the first network and the second network may “click and drag” open document icon 1114, from folder 1100 of room to folder 1082 of room 1080 shared by the second network, such that document 1110 is stored in both folder 1100 and folder 1082. Of course, the present invention also contemplates that such clicking and dragging could result in the document being moved (as opposed to copied) to folder 1082 such that, after such moving, it is no longer stored in folder 1100.

Thus, a member is capable of clicking and dragging one of the documents stored in one folder into a second folder such that the document is shared with members of a second network and is not shared with a member who is not a member of the first network or the second network. The act of clicking and dragging a document enables quick movement of documents and other items within the collaborative work environment. It is notable that this system of sharing information with members of one network but not of another network, permeated throughout this detailed description of the embodiments, ensures data security and protection of confidential information and enables members to come together for the purpose of collaboration within the present invention.

A further integrative functionality is a member-virtual-identity-to-software-application contact-information-importation tool allowing members to import contact information from member profiles via their member virtual identities into the document management tool. For example, a second member could initiate a draft of a letter to a first member by clicking on an icon 1130 on the first member's profile as depicted in FIG. 9, thereby causing the word processor tool depicted in FIG. 14 to appear, except that no folder would be highlighted in window 1062 or window 1064, and window 1066 would contain a letter template addressed to the first member at mailing address 1140, the mailing address 1140 having been imported into the word processing tool, and into the new document, from the first member's profile.

A further integrative functionality is a member-virtual-identity-to-software-application contact-information-importation tool allowing a member to perform a “mail merge,” meaning the production of multiple documents from a single template form and a structured data source, whereby the word processor tool imports contact information from the profiles of the contacts of the member.

A further integrative functionality is a contacts sharing tool allowing members of a network to share a pool (i.e.: collection) of contacts, such that members not of the network of members do not have access to the pool of contacts. For example, in one embodiment, a member of a network could click on icon 1150 on a network profile depicted at FIG. 12, thereby causing a web page displaying a list of links to the profiles of all contacts of all members of the network. The member could use the member-virtual-identity-to-software-application contact-information-importation tool to initiate a draft of a letter to any contact in the pool of contacts by clicking on an icon on the profile of the contact, thereby importing contact information from the profile of the contact into the word processing tool and into the new document, as set forth above; or to perform a mail merge with the word processor tool, thereby causing the word processor tool to import contact information from the profiles of the contacts of the pool of contacts of the network, as set forth above.

The examples above focus on the word processor tool, but the examples also apply to the email tool, the spreadsheet tool, the presentation tool, and other software applications, and such uses are contemplated by and included within the scope of the present invention.

It is contemplated that each community would have a graphical user interface, or GUI, that is particularly adapted to the needs and interests of the members of that community. For example, the law community GUI would likely have ads particularly adapted to goods and services that a lawyer would use such as legal research services, court reporting services, treatise publishing companies, etc. The law community GUI would also present default folder sets within a document management room particularly adapted to a lawyer's work. For example, the default folders with the law community might be titled “briefs,” “motions,” “discovery,” “agreements,” etc. An example is shown in FIG. 14, as more fully described elsewhere in this disclosure.

In a preferred embodiment of the invention, a member who is a member of more than one of these communities (i.e., a lawyer-doctor who is a member of both the law community and the medical community) would be able to switch between community GUI's without re-entering login information or otherwise resetting member information. For example, the member would be able to select a link list, smart field, or drop down menu (or other method known to those in the art of selecting between a plurality of options) located on the home screen that presents the member with possible alternative GUIs for other communities. The lawyer-doctor in this example would, from the member home page within the law community, select a drop down menu which would allow him to select the GUI for the medical community. Upon selecting the medical community GUI, the community GUI would automatically switch to that of the medical community without further effort by the member. In this example, the folder sets and calendars for pre-existing matters would not be changed to fit the new community, but would remain in the form originally created. For example, a folder set for a litigation matter already existing in the law community would not be forced to take on the folder set of the medical community upon the member switching to the medical community GUI. In an alternative embodiment, a switch to a different GUI would require the member to login again, this time selecting the different desired community. In yet another embodiment, upon switching GUI's the matter folders would be rearranged into the folder sets of the new community.

Similarly, the GUI for a medical community would have ads and default folder sets particularly adapted to the medical profession. For example, the medical community GUI would likely have ads from drug manufacturers, medical equipment manufacturers, and the like. The default folder set within a document management room particularly adapted to members of the medical community would be directed to a medical professional's tasks. Examples of default medical community folders include “client medical history,” “MRI scans,” “insurance billing records,” and the like.

In an alternative embodiment, each community might itself have several different GUI's that are selectable by the member. For example, within the law community, there are likely to be several different kinds of practicing lawyers: litigators, transactional, and educators, for example. Each type of lawyer would in turn have a particular set of folders, templates, ads, and applications that are more particularly adapted to their own practice. Thus, in an alternative embodiment, the lawyer would be able to select between a number of Graphical User Interfaces.

In a still further embodiment, members would also be able to select between different GUI's for a particular community based on different but related names of the communities. For example, a legal community based at the website www.lawloop.com would have on GUI, while the same legal community would have a different GUI when accessed at www. law.loop.com. Members accessing the community from www.lawloop.com would be able to instantly switch to the www.law.loop.com GUI without typing the new URL or otherwise reloading a page. Instead, the GUI would change before the member's eyes upon selection of the alternate GUI. Selection could occur via a drop-down menu, a selection button, a smart field (i.e., a field where the information is typed in, from which the community can auto-fill or auto-complete with possible matches) or via any other method of selection known to those of skill in the art.

It is contemplated that each community would also have specialized back office applications that are particularly adapted to benefit the professional. As used in this context, an “application” is an interactive service or software program, typically accessed from the members home page within the community or network. Thus, an application could be a word processor, a spreadsheet application, or an application be directed to a more specialized task. Additional examples of back office applications that are particularly adapted to a profession are included below.

In one embodiment, members also have access to a financial management tool which is integrated with the social networking functionalities, document management functionalities and integrative functionalities described above. A further integrative functionality allows members of a network to use the financial management tool to remotely and collectively manage time-keeping/invoicing records and data and accounting/check-writing records and data.

The financial management tool comprises software applications allowing members to remotely and collectively manage time-keeping/invoicing records and data and accounting/check-writing records and data. One of the software applications is a time-keeping/invoicing tool such as Prolaw® Transactions or AbacusLaw®, and includes all of the features of Prolaw® Transactions or AbacusLaw®, which time-keeping/invoicing tools and features are fully described in the prior art, such disclosures incorporated herein by reference.

One of the software applications is an accounting/check-writing tool such as Prolaw® Journals or AbacusLaw®, and includes all of the features of Prolaw® Journals or AbacusLaw®, which accounting/check-writing tools and features are fully described and enabled in the prior art, such disclosures incorporated herein by reference. The member owning the profile depicted at FIG. 6 described above may access the financial management tool by clicking on a “Time-Keeping/Invoicing” icon on his/her home page like the “Emails” icon on the home page depicted at FIG. 5, or clicking on an “Accounting/Check-Writing” icon on his/her home page like the “Word Processing” icon on the home page depicted at FIG. 5. For example, a law community would likely have a document production and document stamping tool, a client billing or time tracking tool, and a legal research tool, and a financial management tool, among others. A medical community might include such back office applications as a patient billing tool, an insurance billing tool, a client chart organization tool, a medical symptoms and diagnostic tool, a client appointment scheduling tool, and a financial management tool, for example.

As described more fully in related application Ser. No. 13/011,655 to Zuber, incorporated by reference, the preferred embodiment of the financial management tool, would include a billing application that would allow a member of a legal community to track time spent on a particular project, assign that time to a particular client, and also assign a particular hourly rate to each attorney work on the project. Similar to the law community billing tool, the medical community billing tool would allow members to track procedures, consultations, and office visits by patients, and would also allow the member to assign prices or fees to each of these items. The preferred embodiment of the accounting application described above would allow members of the community to track expenses, accounts payable, accounts receivable and the like, that are customary in their profession. By way of example, an accounting tool in a law community would include expense categories for legal malpractice insurance, legal research fees, court filing fees, messenger fees, deposition fees, and expert witness fees, among others. Similarly, an accounting tool in a medical community would include expense categories for medical malpractice insurance fees, medical equipment expenses, pharmaceutical expenses, and the like.

The preferred embodiment of the invoicing tool described above would allow members of the community to create invoices or bills to be sent to clients. In the preferred embodiment, the invoicing tool would gather together information from the billing tool and the accounting tool in creating the invoice for the client. An invoicing application particularly adapted to the law community, for example, would create invoices on a monthly basis for services performed and fees incurred. By contrast, an invoicing application particularly adapted to the medical community might create invoices or bills following each office visit or procedure by a given patient. Accordingly, the invoicing tool in the preferred embodiment would be customized to reflect the needs of the particular community within which the tool is being used.

These specialized applications might be specific to only one particular community, or they may be common to more than one community. For example, a client appointment scheduling tool might be common to the medical community, the dental community, the accountancy community, and others. To be sure, general office tools such as a word processor, spreadsheet, and the like would be common to all communities.

Cross-Community Interaction

It is an object of this invention to provide a method whereby members of one community can interact easily with members of another community. Such cross-community interaction allows members to use their member profile from their own community to join networks of other communities upon invitation, and without creating a new member profile in that other community. When a member interacts with other communities, he or she can take advantage of the applications and tools available to members of the other community, even when those applications and tools are not normally available in the member's home community.

Returning again to the doctor and lawyer example described above, it is easy to see the advantages of interacting across communities. The lawyer in this example creates a network within the law community and invites the doctor to join that network. For this example, we will call this new network created by the lawyer the “cross-over network.” The cross-over network is hosted (in this example) in the law community. Accordingly, those tools and applications that are normally available to members of the law community are available to all members of the cross-over network. Thus, when the doctor is interacting within the cross-over network, the doctor would have access to the law community's document production and review application, among other applications and tools. Accordingly, the lawyer could ask the doctor to review certain documents hosted in the network and available via the document review application, and the doctor could easily do so by accessing the cross-over network and associated tools and applications.

Functioning solely within the medical social networking community the doctor would not have access to the document review application. However, because the doctor is part of a cross-over network within the law community, that tool is available to him while functioning within that network.

Another advantage of cross-community interactions is that members of cross-over networks are able to easily share contacts in a common contact pool. As described above, this feature is normally available only to members of the same community. In our example, when the doctor joins the lawyer's cross-over network, that doctor is allowed to pool his contacts within the cross-over network. In this manner, members of the cross-over network are introduced not only to new contacts within the law community, but to a much enlarged pool of contacts within the medical community as well. If the doctor later joins a cross-over network hosted in the accounting community, the contacts are spread to an even greater extent—lawyers, doctors, and accountants are now all part of a single contact pool within this hypothetical accountancy cross-over network.

Another advantage associated with sharing contacts in a cross-over community is that the newly acquired contact information can be easily incorporated into documents using the document management tools available within the cross-over network. Thus, the doctor's member profile (from the medical community) would be added to the lawyer's pool of contact profiles. Thereafter, if the lawyer were to draft a letter to the doctor, the doctor's contact information would be automatically incorporated into the letter via the mail merge function of the document management tool. The mail merge would draw from the information in the doctor's profile. Likewise, telephone calls via voice-over internet protocol, emails, or instant messaging applications would access the doctor's contact information from the doctor's medical community profile.

Security and Access Control

The present invention contemplates that networks may erect methods of preventing some members from participating in a network. Additionally, members may be required to present identification credentials to enable a member virtual identity and/or to access certain networks. For example, to ensure a member is who they say they are, they may be required to properly present identification credentials, such as a password, to access or enable their member virtual identity. Many other methods of identity verification may be employed to ensure security is maintained. For example, verifying a member's identity may include, in addition to entry of a password (whether entered via text input, entered via image input, or entered orally), thumbprint verification, fingerprint verification, eye-scan verification, voice verification, or DNA verification.

Further security protocols may be used to ensure that only certain members be allowed to access certain networks. For example, a network of lawyers from separate law firms collaborating on a project may be required to prove they are members of one of the firms, either through a password, a digital certificate on the computer they are accessing the network from, or via any other known method of verifying access. Broader networks of lawyers not specific to a particular project may require proof of licensure of a country's or state's bar examiners or court system.

A network administrator may be assigned control over member access to the collaborative work environment and the networks therein. A network administrator may be assigned the ability to add or delete members from a particular network. One method of adding or deleting members is to click on an icon representative the member's virtual identity. A network administrator may also be add or delete members in bulk; one method of doing so it is to highlight several members' virtual identities and drag them to an icon representative of a network virtual identity.

### Additional Aspects of the Invention

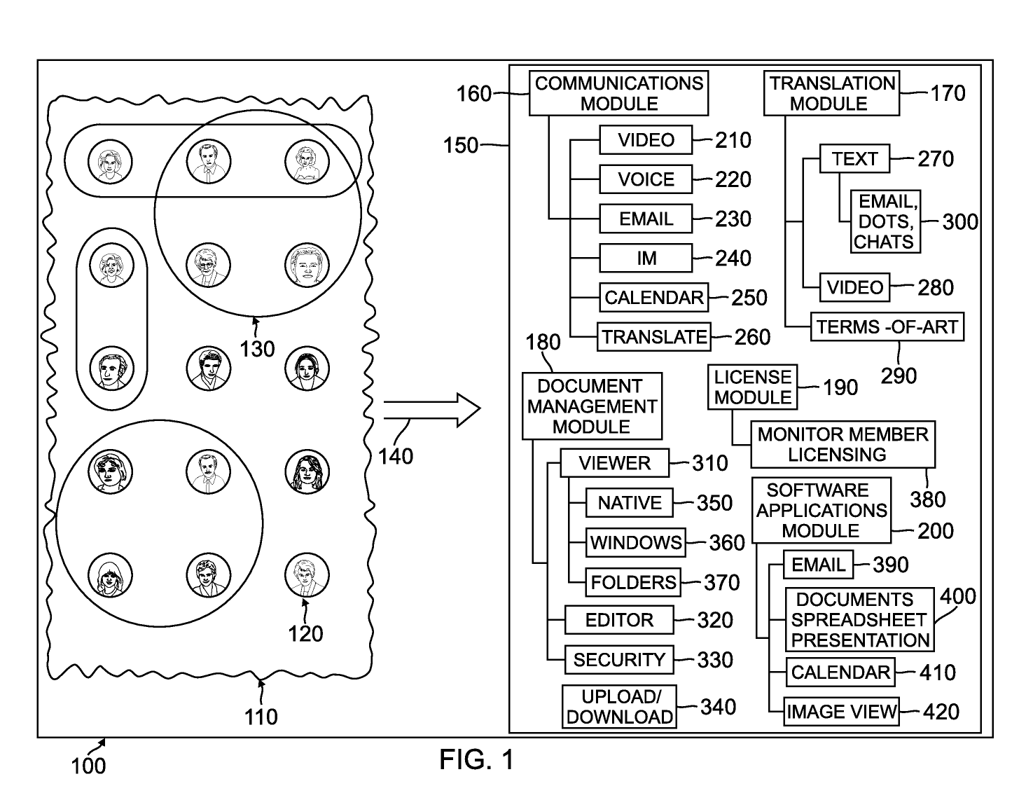

FIG. 1 shows a secure, network-based collaborative work environment 100 according to the present invention. The secure, network-based collaborative work environment 100 allows one or members 120 of an online community 110 to access and utilize several integrative functionalities 150 as fully described herein. The one or more members may be grouped together into one or more networks of members 130.

Members 120 of the online community 110 have an account with the online community 110 which defines a member virtual identity 640 associated with the member 120. The member's account and virtual identity 640 form a member profile which conveys information about the member 120. The member virtual identity 640 is an online representation of that member 120 and may take many different forms. For example, a member's 120 webpage or collection of web pages may be considered a member virtual identity 640. The member virtual identity 640 may be represented by an icon.

A network 130 within the online community 110 may also have an account with the online community 110 which defines a network virtual identity 650 associated with the network 130. The network's account and virtual identity 640 form a network profile which conveys information about the network 130. The network virtual identity 650 is an online representation of that network 130, may take many different forms, and like a member virtual identity 640, may be represented by an icon. Also like the member virtual identity 640, a network 130 may be represented by a webpage or collection of web pages that may be considered a network virtual identity 650.

The secure, network-based collaborative work environment 100 and online community 110 are available and accessible to the one or more members 120 via a portal 140 to the “cloud” in a computing environment. The secure, network-based collaborative work environment 100 and online community 110 are therefore resident in an online architecture in the “cloud” in which the portal 140 allows the one or more members 120 to collaborate with one another. The present invention therefore contemplates that the secure, network-based collaborative work environment 100 and online community 110 are an extension of cloud computing in which a plurality of integrative functionalities 150 are accessible to the one or more members 120 as an overlay of collaborative networking and collaborating tools.

The plurality of integrative functionalities 150 available to the one or more members 120 includes at least a communications module 160, a translation module 170, a document management module 180, and a software applications module 200. At least one additional integrative functionality 150 includes a license module 190 which controls monitoring of licensing of the one or more members 120. License module 190 further includes a sub-module 380 for performing the task of license monitoring. Each of these integrative functionalities 150 include several sub-modules for executing various algorithms associated with the integrative functionalities 150 and allow the one or more members 120 to perform different tasks within the online community 110.

The communications module 160 of the integrative functionalities 150 includes sub-modules for video conferencing 210, voice conferencing 220, email 230, various forms of instant messaging 240, calendaring 250, and translation 260. The translation module 170 of the integrative functionalities 150 includes a text sub-module 270 that further includes capabilities for translating emails, documents, and chats 300. Translation module 170 also includes a video translation sub-module 280 and a terms-of-art translation sub-module 290.

The document management module 180 includes several sub-modules designed to facilitate collaboration amongst members 120 who are working with various documents. The document management module 180 includes a viewer sub-module 310 that has further sub-modules that enable the viewing of native documents 350, provide various options for windows management 360, and various options for folder management 370. The document management module 180 also includes an editor sub-module 320 and a security sub-module 330. Addition sub-modules for the document management sub-module 180 include an upload/download sub-module 340 that manages the upload and download of documents within the online community 110.

The software applications module 200 includes several sub-modules offering software applications to the one or more members 120. Each of these sub-modules allows the one or more members 120 to conduct various activities within the online community 110. For example, the software applications module 200 includes an email sub-module 390 which allows a member 120 to access email applications for managing, sending, receiving, deleting, storing, and aggregating email. The document, spreadsheet, and presentation sub-module 400 allows a member 120 to access one or more applications for word processing, spreadsheeting, and preparing presentations. A calendar sub-module 410 allows access to applications for maintaining a calendar of important dates and meetings. Within the law community, for example, the calendaring sub-module would not only allow the member to manually create appointments or calendar events, but also to take advantage of automatic calendaring tools, such as those found in products offered by Prolaw®. As an example, when a member of the law community using the calendaring sub-module to schedule a hearing, the calendaring sub-module would then be able (in its default mode) to calculate deadlines for submitting briefs or evidence for use in that hearing. This type of automatic calendaring takes advantage of the laws of each jurisdiction to automatically calculate the due dates for each event. Likewise, members of a banking community would be able to use the calendaring sub-module to schedule important dates relating to a loan, such as payment dates, dates of balloon payments, and the like. Other communities would be able to take advantage of the calendaring sub-module to automatically track important dates within each respective industry. Similarly, members of a medical community would use a calendaring tool particularly adapted to meet the needs of the medical professionals who make up the medical community. For example, instead of scheduling court hearings and filing dates, the medical calendaring tool would automatically calendar deadlines for check-ups, vaccinations, or the like. It is an object of this invention to provide a calendaring application that is particularly adapted to the various industries discussed herein. Accordingly, it will be understood by those of skill in the art that the calendaring applications are readily adaptable to the particular needs of the industry served, even if not specifically described in this disclosure.

Many additional applications sub-modules are contemplated with the present invention. Another such sub-module may be an image viewing sub-module 420 which allows a member 120 to easily view documents with a number of different applications for viewing different kinds of documents, particularly in connection with the document, spreadsheet, and presentation sub-module 400. Note that the image viewing sub-module 420 may be different than the viewer sub-module 310 associated with the document management module 180.

It is to be noted that many different applications are contemplated for the email sub-module 390, the document, spreadsheet, and presentation sub-module 400, the calendar sub-module 410, the image viewing sub-module 420, and the other applications sub-modules contemplated by the present invention.

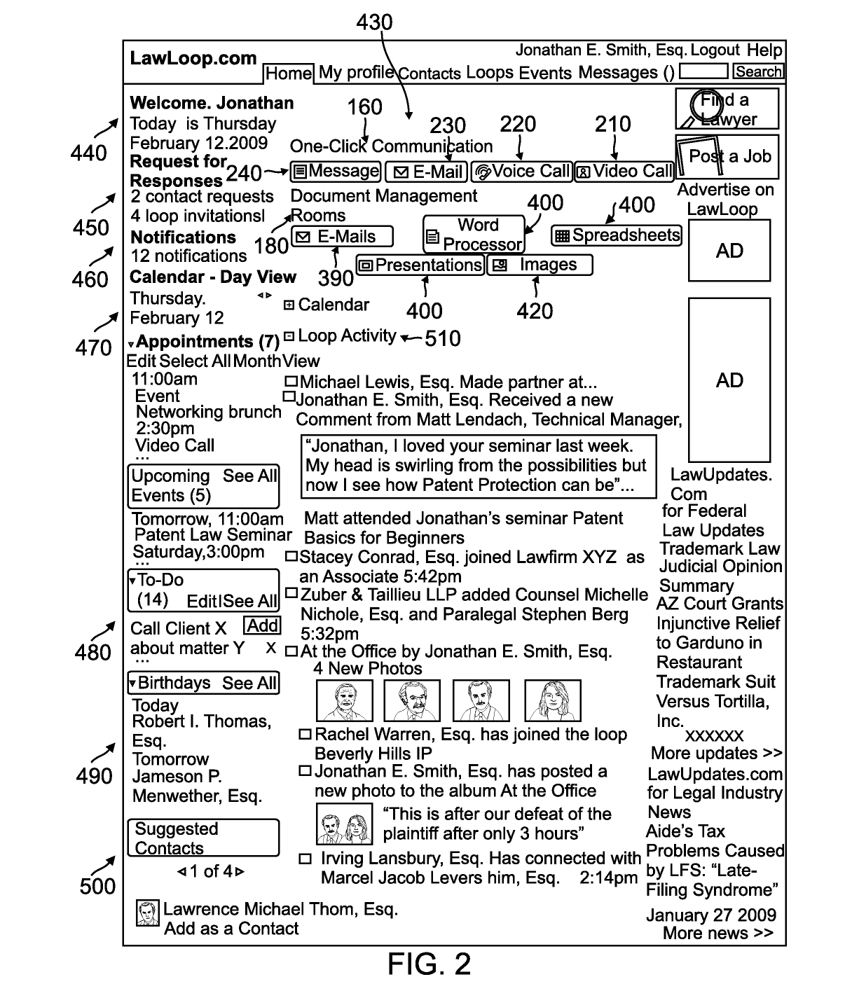

FIG. 2 shows an exemplary graphical implementation of one aspect of the present invention. In FIG. 2, a member's 120 home page on the graphical user interface 140 is depicted. The member's 120 home page 430 of the online community 110 on the graphical user interface 140 shows one embodiment of several integrative functionalities 150 accessible to the member 120.

At the home page of the online community 110 on the graphical user interface 140, integrative functionalities such as the communications module 160 and document management module 180 are shown. In this embodiment, the communications module 160 has sub-modules 210, 220, 230 and 240 available as one-click options for a member 120. Each of these one click options are available to the member 120 as “buttons” on the graphical user interface 140. Specialized applications might also appear here. In the case of the law community, the specialized applications might include a document review and production tool or legal research tools, for example (e.g., CONCORDANCE® or iCONECT®). Specialized tools within the medical community might include a patient chart organization tool, an x-ray analysis tool, or a medical research tool, for example (e.g., AllScripts™ or eClinicalWorks®). Examples of specialized tools within the architectural community might include drafting tools or estimate tools (e.g., Autodesk® or Punch!CAD™). It is contemplated that applications tailored to other professions are included within the scope of this disclosure. For example, applications that are particularly adapted to the biomedical community, banking community, dental community, and others are within the scope of this invention.

The particular specialized applications are not critical to this application, but are contemplated to exist. In fact, it is anticipated that additional specialized applications for each discrete community do exist and are included within the scope of this invention, even if not specifically enumerated herein.

FIG. 2 also shows other information available to a member 120 at the home page 430 of the online community 110. The present invention contemplates that many different types of information can be depicted on the home page 430 of the online community 110, and therefore this description of exemplary information provided is not intended to be exhaustive or to limit the invention to the precise forms disclosed. Information presented may include a virtual member identity 440, a request for responses section 450, and a notifications section 460. Other information presented may include a calendar section 470 and to-do section 480. A birthdays section 490 and a suggested contacts section 500 may also be included. Different views of any of these types of information may also be provided. For example, calendar section 470 may be provided in a day view, a monthly view, in a weekly view, or any other type of calendar view. Drop-down or drop-across menus may also be accessible to select from different views and further information available within any of these sections of information. Members 120 may also be able to click on any information listed on the home page 430 and go to a different screen providing further information about what was just clicked on.

Other types of information available in FIG. 2 include loop activity 510. As with other types of information described above, a member 120 may click on any sub-information section listed under loop activity 510 and enter into a loop 520.

FIG. 2 also depicts ads on the right hand side of the figure. It is contemplated that the ads shown here may be particularly adapted or targeted to the specific needs or interests of the members of the community. For example, ads appearing in the law community would be directed to services for lawyers; ads within the medical community would be directed to services useful to doctors, etc. Although the ads are arranged vertically on the right hand in FIG. 2, this particular location is not required and is not intended to limit the scope of the invention.

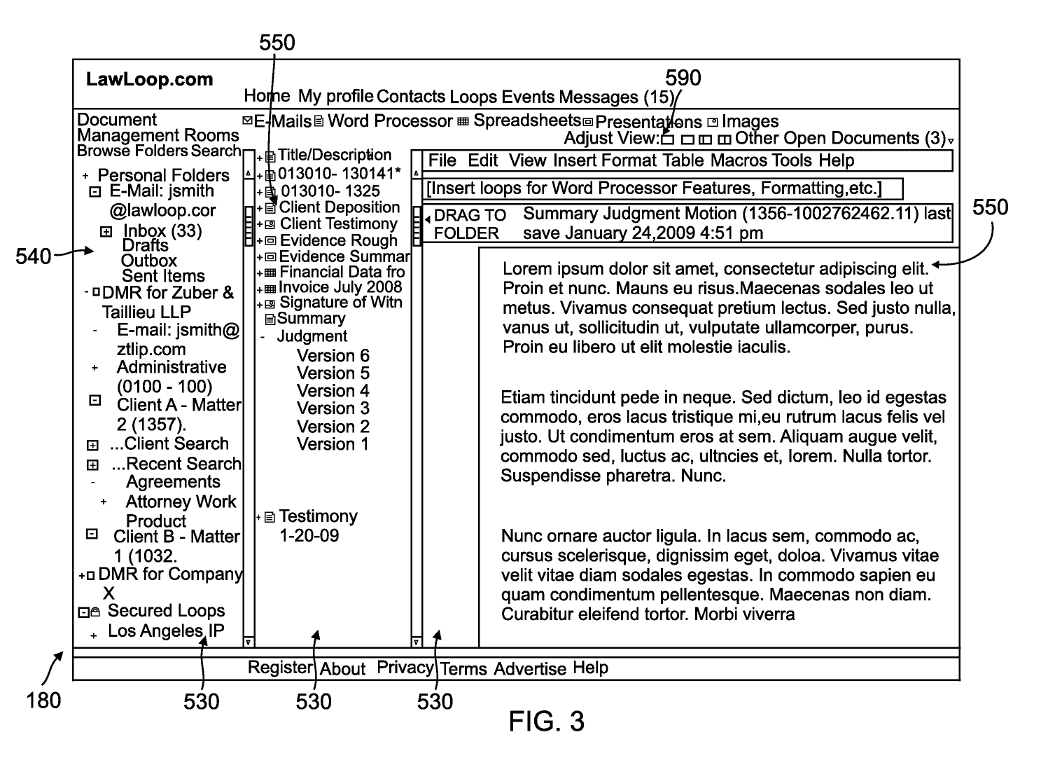

FIG. 3 shows an exemplary graphical implementation of another aspect of the present invention showing multiple windows 530 of a document management module 180. In FIG. 3, document management module 180 is divided into a folder window 530 showing multiple folders 540 as managed by the viewer sub-module 310, windows sub-module 360, and folders viewer sub-module 370. FIG. 3 also shows a document window 530 showing multiple documents 550 within a particular folder 540 as managed by the viewer sub-module 310, windows sub-module 360, and folders viewer sub-module 370. A viewer 590 in window 530 shows a document 550 selected from the list of documents 550.

The document management module 180 of the integrative functionalities 150 provides members 120 with several features for working with, editing, manipulating, and managing documents. Within the larger context of collaboration within a secure loop in the online community 110, members 120 and groups or networks of members 130 can come together with the present invention and work with documents using one or more of the integrative functionalities 150. Actions that a member 120 may take using the document management module 180 include clicking on an icon on a member virtual identity 640 existing in the context of the online community 110 and thereby giving the member 120 associated with such member virtual identity 640 access to (or retracting access of the member 120 associated with such member virtual identity 640 to) a document management room shared by a network that at least some members 120 associated with member virtual identities 640 do not have access to. Other actions include dragging a document stored in a first folder containing documents shared by members of a first network of members 130 (and not shared with members 120 not of said first network 130) to a second folder containing documents shared by members of a second network 130 (and not shared with members 120 not of said second network 130), such that the document is shared with members of the first network 130 and members of the second network 130, wherein at least one of said members of said second network 130 is not also a member 120 of said first network 130.

Still other actions include dragging a document stored in a first folder containing documents shared by members of a first network of members 120 (and not shared with members 120 not of said first network 130) to a second folder containing documents shared by members of a second network 130 (and not shared with members 120 not of said second network 130), such that the document is shared with members of the first network 130 and members of the second network 130, and such that the document appears on the second network virtual identity 650 page (e.g.: the Secure Loop Profile page), wherein at least one of said members of said second network 130 is not also a member 120 of said first network 130.

FIG. 4 is an exemplary graphical implementation of another aspect of the present invention showing a profile page 560 of a member 120. The profile page 560 of a member 120 shows various information about the member represented by the member's virtual identity 640, including areas of practice 620, languages 630, a lawyer rating 610, a blog section 570, and loop activity 510. The profile page 560 may also show a contact file management tool 580, loops 520, and distribution lists 600. Links may be provided to content such as the profile page 560 itself, the contact file management tool 580, loops 520, or any other content available to members 120 of the online community 110. Clicking on an icon representative of the member virtual identity 640 displays the information on the profile page 560. A member's 120 contacts 660 may be represented by an icon, and another member 120, regardless of network 130 membership, may simply import his or her contact information by clicking on the icon and dragging it to his or her contacts section of the member virtual identity 640.

The contact file management tool 580 is an integrative functionality 150 that may include files (i.e.: like Outlook® contact files) which consist of contact information imported from at least one of other member virtual identity 640. Allowing importation of a member's 120 contacts 660 from another member's 120 member virtual identity 640 eliminates the need to get someone's business card and have a secretary or assistant add their information to new Outlook® contact file. Therefore, with this integrative functionality 150 of the present invention, one can very simply add contacts from a member's virtual identity 640, and a contact file will be created automatically.

The contact file management tool 580 is a powerful tool for allowing members 120 to easily import contacts 660 from other members' member virtual identities 640. It also allows members 120 to quickly share contacts 660 with each other and within networks, and quickly and seamlessly import and export contacts 660 from third party applications. Therefore, the contact file management tool 580 is configured to integrate one's contacts from multiple sources, and to integrate new contacts 660 therein. The contact file management tool 580 is also configure to adhere to members 120 excluded from certain networks, so that certain members 120 do not have access to other members' 120 contact information.

FIG. 14 shows an exemplary view of the document management tool, as described more fully above. The screen in FIG. 14 shows a document management tool that would be viewed by a member of the law community. As seen in window 1062, the law community folders relate to the particular needs of the lawyer, providing folders for depositions, testimony, and summary judgment. In this particular view, those lawyer-specific folders are labeled “Agreements,” “Attorney Work Product,” “Briefs,” “Discovery,” etc. In a preferred embodiment, each network within the law community would, as a default scenario, include these lawyer-specific files upon creation. Likewise, when a lawyer-member visits networks within the legal community, the lawyer-member is presented in each case with the default view.

A similar view within the medical community would show folders particularly adapted to the needs of those within the medical profession. For example, the folders might include such titles as “patient interview,” “diagnoses,” “treatments,” etc. In the member's home community (law community in the case of a lawyer) the member is presented with this default view. When the member interacts within a cross-over network, the member is presented instead with the default folders of the host community. As an example, a doctor (i.e., a member of the medical community) who interacts with a network within the legal community would be presented with the default folders of the legal community. Moreover, in a preferred embodiment, when the doctor-member interacts with a network within the legal community, the GUI as viewed by the doctor changes before the doctor's eyes. There is no need to reload the screen or navigate to another page. Rather, the GUI transforms from the medical community GUI to the legal community GUI as the doctor chooses to interact with the legal community network.

In an alternative embodiment, a member interacting within a cross-over network would be presented with the default view shown in FIG. 14. However, the member would also be presented with an additional folder that would contain the subfolders of the cross-over network. Thus, the member would interact with the familiar view of his home community, while also being able to also access the features and benefits of the cross-over network's host community.

It is to be understood that other embodiments may be utilized and structural and functional changes me be made without departing from the scope of the present invention. The foregoing descriptions of the embodiments of the invention have been presented for the purposes of illustration and description. It is not intended to be exhaustive or to limit the invention to the precise forms disclosed. Accordingly, many modifications and variations are possible in light of the above teachings. It is therefore intended that the scope of the invention not be limited by this detailed description.

1. A plurality of secure, online social networking communities comprising:
a first community and a second community of said plurality of social networking communities, each of said first and second communities further comprising a plurality of members, each of such members having a member profile, which member profile is enabled with a plurality of social networking functionalities;
a first network of members that excludes at least one member of the first community, and a second network of members that excludes at least one member of the second community, whereby members of the first network share access to a first set of documents in a secured remote environment and members of the second network share access to a second set of documents in a secured remote environment, such that members not belonging to the first network do not have access to the first set of documents and members not belonging to the second network do not have access to the second set of documents;
a document management tool for managing documents comprised of a document filing tool and at least one software application chosen from a group consisting of a message application, an email application, word processor application, a spreadsheet application, a presentations application and an images application, whereby the document management tool enables said members of said first and second networks to remotely manage documents of said set of documents
wherein at least one member profile of the first community may interact with at least one member profile of the second community.

2. The method of claim 1, whereby a member of the first community may add a member of the second community as a contact.

3. The method of claim 1, whereby a member of the second community who is not a member of the first community can be added to the first network.

4. The method of claim 1, whereby a member of the second community who is not a member of the first community can access the first set of documents.

5. The method of claim 1, whereby member profiles of the second community appear in profile searches effected on the first of the plurality of communities.

6. The method of claim 1, wherein said first community comprises a first GUI and said second community comprises a second GUI.

7. The method of claim 1, wherein said first community comprises at least one application particularly adapted to a first industry and said second community comprises at least one application particularly adapted to a second industry, wherein the first industry is different from the second industry.

8. The method of claim 1, whereby said first community comprises a billing application particularly adapted to a first industry and said second community comprises a billing application particularly adapted to a second industry, wherein the first industry is different from the second industry.

9. The method of claim 1, whereby said first community comprises a billing application particularly adapted to the legal industry and said second community comprises a billing application particularly adapted to the medical industry, whereby the first billing application enables a member of the first community to assign hourly rates to attorney members of the first community and the second billing application enables a member of the second community to assign prices to medical procedures.

10. The method of claim 1, whereby said first community comprises an accounting application particularly adapted to a first industry and said second community comprises an accounting application particularly adapted to a second industry, wherein the first industry is different from the second industry.

11. The method of claim 1, whereby said first community comprises an accounting application particularly adapted to the legal industry and said second community comprises an accounting application particularly adapted to the medical industry, whereby the first accounting application includes at least one expense category chosen from a group consisting of legal malpractice insurance fees, legal research fees, court filing fees, deposition transcript fees, expert witness fees; and the second accounting application includes at least one expense category chosen from a group consisting of medical malpractice insurance fees, medical equipment, and medicine.

12. The method of claim 1, whereby said first community comprises an invoicing application particularly adapted to a first industry and said second community comprises an invoicing application particularly adapted to a second industry, wherein the first industry is different from the second industry.

13. The method of claim 1, whereby said first community comprises an invoicing application particularly adapted to the legal industry and said second community comprises an invoicing application particularly adapted to the medical industry, whereby the first invoicing application produces invoices for legal services and the second invoicing application produces invoices for medical services.

14. The method of claim 1, whereby the first community has a domain name referencing a first industry and the second community has a domain name referencing a second industry, wherein the first industry is different from the second industry.

15. The method of claim 1, whereby the first community is particularly adapted to a first industry and the second community is particularly adapted to a second industry, wherein the first industry is different from the second industry.

16. The method of claim 1, whereby the first community has folders particularly adapted for a first industry and the second community has folders particularly adapted for a second industry, wherein the first industry is different from the second industry.

17. The method of claim 1, whereby the first community has default document management folder sets particularly adapted for a first industry and the second community has default document management folder sets particularly adapted for a second industry, wherein the first industry is different from the second industry.

18. The method of claim 1, whereby the first community has document templates particularly adapted for a first industry and the second community has document templates particularly adapted for a second industry, wherein the first industry is different from the second industry.

19. The method of claim 1, whereby said first community comprises a calendaring application particularly adapted to a first industry and said second community comprises a calendaring application particularly adapted to a second industry, wherein the first industry is different from the second industry.

20. The method of claim 1, whereby said first community comprises a calendaring application particularly adapted to the legal industry and said second community comprises a calendaring application particularly adapted to the medical industry, whereby the first calendaring application automatically creates calendars for legal events and the second calendaring application automatically creates calendars for medical events.
